(19) United States
(12) Patent Application Publication
(10) Pub. No.: US 2003/0188300 A1
(43) Pub. Date: Oct. 2, 2003

(54) Parallel processing system design and architecture

(76) Inventor: Pilla G. Patrudu, Norwood, MA (US)

Correspondence Address: PILLA GURUMURTY PATRUDU, 135 C OLDE DERBY ROAD, NORWOOD, MA, 02062, US

(21) Appl. No.: 09/785,342

(22) Filed: Feb. 18, 2001

Related U.S. Application Data
(60) Provisional application No. 60/183,660, filed on Feb. 18, 2000.

(51) Int. Cl. G06F 9/45

(52) U.S. Cl. 717/149; 717/101

(57) ABSTRACT

An architecture and design called Resource control programming (RCP), for automating the development of multithreaded applications for computing machines equipped with multiple symmetrical processors and shared memory. The Rcp runtime (0102) provides a special class of configurable software device called Rcp Gate (0600), for managing the inputs and outputs and user functions with a predefined signature called node functions (0500). Each Rcp gate manages one node function, and each node function can have one or more invocations. The inputs and outputs of the node functions are virtualized by means of virtual queues and the real queues are bound to the node function invocations, during execution. Each Rcp gate computes its efficiency during execution, which determines the efficiency at which the node function invocations are running. The Rcp Gate will schedule more node function invocations or throttle the scheduling of the node functions depending on the efficiency of the Rcp gate. Thus automatic load balancing of the node functions is provided without any prior knowledge of the load of the node functions and without computing the time taken by each of the node functions.

### CROSS-REFERENCE TO RELATED APPLICATIONS

This application is entitled to the benefit of Provisional Patent Application No. 60/183,660 filed 2000 Feb 18.

### FIELD OF INVENTION

This invention relates to automating the development of multithreaded applications for computing machines equipped with multiple symmetric processors and shared memory.

### BACKGROUND-DESCRIPTION OF PRIOR ART

Multithreaded applications for symmetrical multiprocessor (SMP) machines, require a significant amount of synchronization code to work properly. The developers are required to develop the synchronizing code, by using the primitive synchronization constructs like spin locks, event objects, semaphores, and critical sections. These primitive constructs are provided by the host language, operating system or by third party libraries.

Developers trying to harness the power of multiple processors of a SMP machine, often find that the synchronization code, is more complex, than the applications which they are developing, since the synchronizing code demands professional computing skills. In other words developers attempting to harness the power of SMP machines had to transform themselves as psuedo computer scientists.

Some programming languages like Java, provide language constructs to simplify the synchronization. However these language constructs are still far away from abstracting the synchronization requirements, and still require significant coding and understanding of the synchronizing mechanisms. One of the major problems with the java language constructs for synchronizing is that they are too naïve and may incur significant performance loss in some applications, unless intelligent objects or components are built using the basic language constructs. Again the developer has to acquire professional computing skills to harness the power of the SMP machines.

Despite the primitive synchronization constructs provided by the operating systems, and the language constructs, developers still have to work around dead locks, since there are no known constructs which provide transactional locking, that is, a mechanism by which a group of resources may all be acquired, or none of them acquired.

Due to the excessive complexity of developing synchronizing code, parallel computing using SMP machines is still relatively unexploited, despite the cheap prices of the systems.

Data flow computing is an alternative to thread based computing, however data flow computing mechanisms are implemented in hardware, and the machines are called data flow computers. Data flow computing constructs are executed in parallel, and the synchronization requirements are automatically detected and implemented by the hardware. These machines are quite expensive and are still not found in widespread commercial use.

### SUMMARY

The present invention is based on the key features of the data flow architecture, and the threading model for parallel computing, and the resulting hybrid architecture is named “Resource Control Programming (RCP)” architecture. Rcp is a software architecture, which utilizes coarse grained scheduling and data flow computing architecture. Applications implementing the Rcp architecture, can make use of Rcp runtime modules and Rcp runtime libraries. The Rcp runtime libraries provide extensive run time support, for most of the synchronization requirements of the application.

### OBJECTS AND ADVANTAGES

The most important objects and advantages of the present invention, are:

a) The management of inputs/outputs and functions, is undertaken by the Rcp runtime library, and the developer is relieved from the trouble of coding the complex synchronization code.

b) The Rcp runtime library automatically detects and balances the load, which is a great boon for developers, since load balancing is a very complex issue in parallel computing.

Further objects and advantages of the present invention are:

a) The threading model is abstracted by the Rcp architecture, and the Rcp runtime creates and manages the threads and performs controlled termination at the end of the application.

b) The application design and development are clearly segregated so that a person with greater knowledge of the application can design the application, and developers with more knowledge of programming languages can develop the application.

c) The application design is independent of the host language, operating system, and can be ported to other host languages or operating systems without any changes.

### DRAWING FIGURES

The present invention will be described with reference to the accompanying drawings, wherein:

FIG. 1 is a block diagram illustrating the Rcp runtime library

FIG. 2 is a block diagram illustrating the schematic of a Queue

FIG. 3 is a block diagram illustrating the schematic of a Queue Array

FIG. 4 is a block diagram illustrating the schematic of a Virtual Queue

FIG. 5 is a block diagram illustrating the schematic of a Node function

FIG. 6 is a block diagram illustrating the schematic of a Rcp Gate

FIG. 7 is a block diagram illustrating the Rcp Gate Interconnections

FIG. 8 is a block diagram illustrating the Rcp Translator

FIG. 9 is a block diagram illustrating the schematic of Rcp Load Image File layout

FIG. 10 is a block diagram illustrating the schematic of Rcp Load Image Header Structure

FIG. 11 is a block diagram illustrating the schematic of a Frame Structure

FIG. 12 is a block diagram illustrating the schematic of a Worker structure

FIG. 13 is a block diagram illustrating the Rcp runtime Library

FIG. 14 is a block diagram illustrating the schematic of a Run_id structure

FIG. 15 is a block diagram illustrating the schematic of a Queue structure

FIG. 16 is a block diagram illustrating the schematic of a Queue Info structure

FIG. 17 is a block diagram illustrating the schematic of a Node function structure

FIG. 18 is a block diagram illustrating the schematic of a Node Function Info structure

FIG. 19 is a block diagram illustrating the schematic of a Local Ring structure

FIG. 20 is a block diagram illustrating the schematic of a Queue Status structure

FIG. 21 is a block diagram illustrating the schematic of a Queue Data Node structure

FIG. 22 is a block diagram illustrating the schematic of a Queue header structure

FIG. 23 is a block diagram illustrating the schematic of a Lock Structure

FIG. 24 is a block diagram illustrating the schematic of a Queue Array Node structure

FIG. 25 is a block diagram illustrating the schematic of a Bind sequence number structure

FIG. 26 is a block diagram illustrating the schematic of a Virtual Queue Node structure

FIG. 27 is a block diagram illustrating the schematic of a Node function status structure

FIG. 28 is a block diagram illustrating the schematic of a Rcp Gate Node structure

FIG. 29 is a block diagram illustrating the schematic of a bind node structure

FIG. 30 is a block diagram illustrating the schematic of a Node function Invocation structure

FIG. 31 is a block diagram illustrating the schematic of a Rcp runtime Library

FIG. 32 is a block diagram illustrating the schematic of a Rcp runtime Library

FIG. 33 is a block diagram illustrating the Node function configuration of a Sample Application

FIG. 34 is a block diagram illustrating the Rcp gate configuration of Sample Application

FIG. 35 illustrates the Main Function of Sample application

FIG. 36 illustrates the claim Selector Function of Sample application

FIG. 37 illustrates the claim Processor Function of Sample application

FIG. 38 illustrates the Reject Function of Sample application

FIG. 39 illustrates the Payment Function of Sample application

FIG. 40 illustrates the Tables of Sample Application

FIG. 41 illustrates the trace of Sample Application

FIG. 42 illustrates the trace of Sample Application

FIG. 43 illustrates the trace of Sample Application

FIG. 44 illustrates the trace of Sample Application

FIG. 45 illustrates the trace of Sample Application

FIG. 46 illustrates the trace of Sample Application

FIG. 47 illustrates the trace of Sample Application

FIG. 48 illustrates the trace of Sample Application

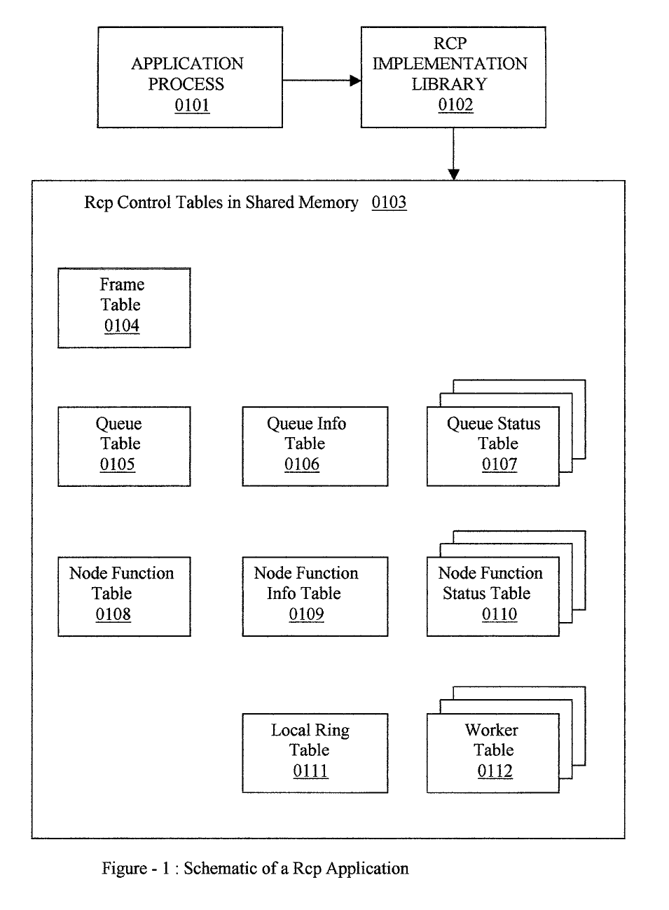

### DESCRIPTION—FIGS. 1 THRU 39—PREFERRED EMBODIMENT

A preferred embodiment of the present invention is shown in FIGS. 1 thru 39.

The Rcp architecture is a set of rules and features, for configuring and executing the applications. The Rcp runtime library is a set of executable functions meant for providing runtime support, to the application utilizing the Rcp architecture. FIG. 1, depicts an application process utilizing the Rcp runtime library.

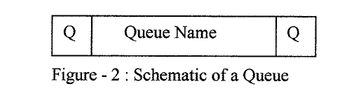

FIG. 2, is a schematic for a queue, which is a container for user data, organized as a fixed number of elements of equal size, and control structures for managing and accessing the elements of the queue.

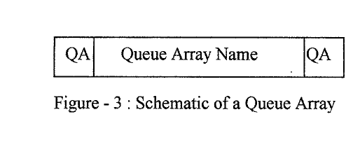

FIG. 3, is a schematic for a queue array, which is a container for a fixed number of queues, and control structures for managing and accessing the queues contained in the queue array.

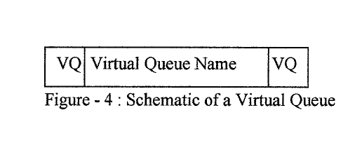

FIG. 4, is a schematic for a virtual queue, which holds a reference to a queue, or a queue array, and an index number, which identifies a queue contained in the queue array.

The queue Q1 0201, the queue array QA1 0301 and the virtual queue VQ1 0401 can be of two types, namely type input, and type input-output, and the type is always referred to as “type input” or “type input-output”.

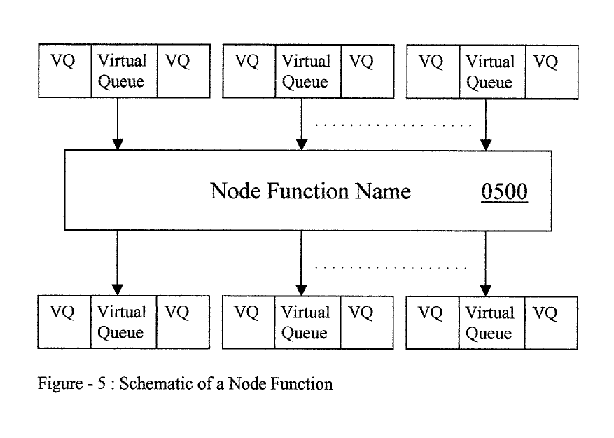

FIG. 5, is a schematic for a Node function, which has an arbitrary number of virtual queues as inputs and outputs. In addition the Node function may have an arbitrary number of invocations. The developer may specify any number of inputs, outputs, and invocations, subject to the condition that they are within the maximum specified by the implementation. Since the inputs and outputs of the Node function are virtual, it cannot operate unless it is bound to real inputs and outputs. Binding inputs and outputs to the Node function is atomic, in the sense, that either all the inputs/outputs are bound or none of then are bound. Binding inputs and outputs to a Node function is a non trivial operation, since multiple invocations of a Node function may be executing concurrently. In order to eliminate this complexity from the user code, and for better management of the inputs and outputs a software device called Rcp Gate is provided by the Rcp architecture, and the functionality of the Rcp gate is provided by the Rcp runtime library.

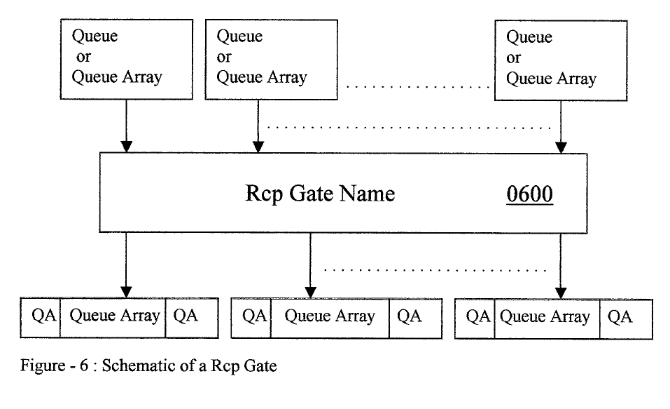

FIG. 6, is a schematic for the Rcp gate G1 0600, which has an arbitrary number of queues or queue arrays as inputs and an arbitrary number of queue arrays as outputs. In addition, Rcp Gate G1 0600 controls exactly one Node function N1 0500, but all the invocations of the Node function N1 0500. The maximum number of inputs, outputs and invocations the Rcp Gate G1 0600 can have is based on the Rcp implementation. The structure of the Rcp Gate G1 0600 must correspond to the structure of the Node function N1 0500, which means that the Rcp Gate G1 0600 and the Node function N1 0600 it is controlling, must have the same number of inputs and outputs, and the type of input or output of the node function N1 0500, must match the type of input or output of the Rcp Gate G1 0600. For example the type of the 2^{nd} input virtual queue of the Node function N1 0600 must match the type of the 2^{nd} input queue array of the Rcp Gate G1 0600.

In the following discussion, input queues, or input queue arrays, means queues, and queue arrays defined on the input side of the Rcp gate. Similarly output queue arrays means ueue arrays defined on the output side of the Rcp gate. The same rule applies to virtual queues, and input virtual queues means virtual queues defined on the input side of the Node function, and output virtual queues means virtual queues defined on the output side of the Node function. As mentioned before, the type is always referred to as “type input” or “type input-output”.

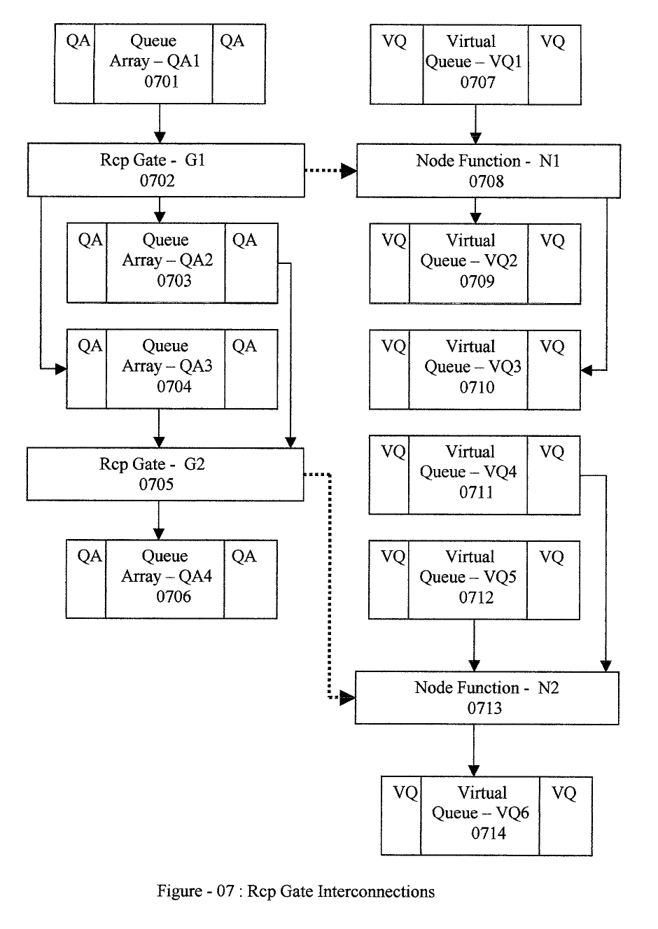

FIG. 7, manifests an interconnection between two Rcp gates. It may be noted that the output queue arrays QA2 0703, QA3 0704 of Rcp Gate G1 0702 are connected to the inputs of Rcp Gate G2 0705, and are the input queue arrays of Rcp Gate G2 0705.

In FIG. 7, Node function N1 0708 is controlled by Rcp Gate G1 0702, and can have a maximum of two invocations as depicted in the figure. Node function N2 0713 is controlled by Rcp Gate G2 0705, and can have a maximum of three invocations as depicted in the figure.

In FIG. 7, Node function N1 0708, has one virtual queue VQ1 0707 as input and two virtual queues VQ2 0709 and VQ3 0710 as outputs. Node function N2 0713 has two virtual queues VQ4 0711, and VQ5 0712 as inputs and one virtual queue VQ6 0714 as output.

It may be noted that the Rcp Gate G1 0702 and the Node function N1 0708 have the same structure, similarly Rcp Gate G2 0705 and Node function N2 0713 have the same structure. However the output queue arrays QA2 0703, and QA3 0704 of Rcp Gate G1 0702 are connected directly to the inputs of Rcp Gate G2 0705, whereas the virtual queues VQ2 0709, and VQ3 0710 on the output side of Node function N1 0708 are independent of the virtual queues VQ4 0711, and VQ5 0712 on the input side of the Node function N2 0713. In other words, Node functions have the same configuration as the Rcp Gates, except that each Node function uses a completely independent set of virtual queues, which are connected only to that Node function.

A worker means a thread and control structures for controlling the thread. The worker executes the code in the node function, whenever inputs and outputs are available for the node function.

A Rcp resource is one of the previously defined entities, namely, queue, queue array, virtual queue, node function, Rcp gate, or worker.

A frame is a partition within the application process. Each frame will execute the same application code, however each frame can start with different initial values, and the processing of a large input can be divided into smaller partitions. The developer can define any number of frames with in the application. The Rcp resources like queues, node functions, and Rcp gates, are owned by all the frames within the application. Each frame independently maintains the status of all the defined Rcp resources and its workers. The developer can specify the number of workers for the frame. Frames are useful when there are a large number of processors within the system. The default number of frames is 1.

The Rcp architecture provides a high level language for defining the application configuration to, and for interacting with the Rcp runtime libraries. The high level language statements are called Rcp Statements.

The Rcp statements can be classified as:

1) Declarative statements for defining the Rep resources and application configuration to the Rcp runtime modules.

2) Executable statements for interacting with the Rcp runtime libraries, to control and access the Rep resources.

All Rcp statements begin with “Exec Rcp” keywords and end with “End Rcp” keywords. Appendix-A describes the available Rep statements in greater detail.

A Rcp resource definition file is a text file, containing declarative Rcp statements for defining Rcp resources, and executable Rep statements for initializing the Rcp resources.

A Rcp program file, is a text file, containing host language statements along with executable Rcp statements for accessing and controlling the Rcp resources.

A Rcp load image file is a binary file containing the Rcp resource definitions in binary format, organized as one or more control tables for each of the Rcp resources.

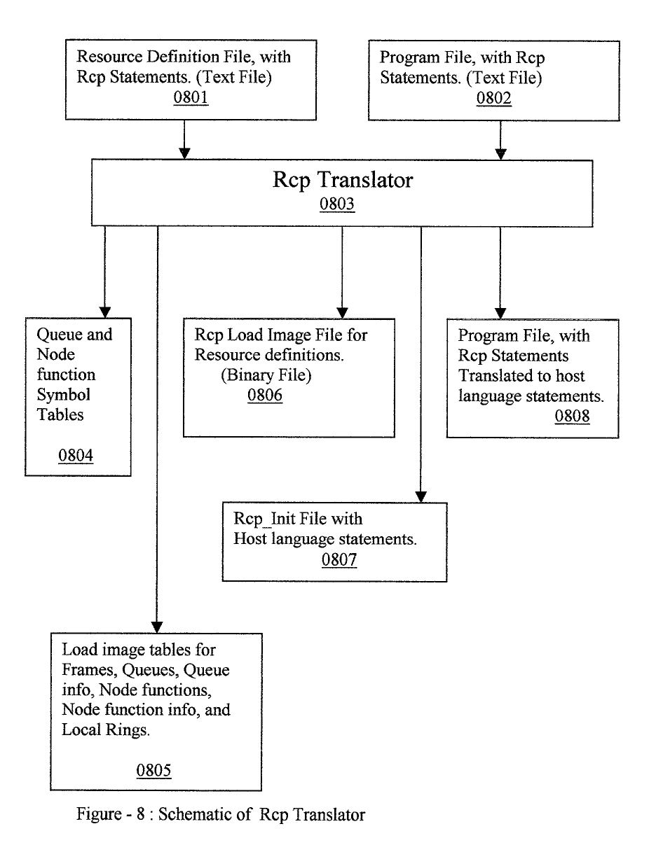

Rcp Translator is a Rcp implementation module, which translates the declarative Rcp statements into control tables, for later use by the Rcp runtime libraries. The executable Rcp statements are translated into equivalent host language statements. FIG. 8, describes the Rcp Translator, which has the Rcp resource definition file 0801, and Rcp program files 0802 as inputs, and the Rcp load image file 0806, as output.

The Rep translator will generate a text file called Rcp init file 0807, which contains a copy of the resource definitions contained in the Rep resource definition file, where the declarative Rep statements are marked as comments, using the host language commenting scheme, and the executable Rep statements are also commented out, but replaced by equivalent host language calls into Rep runtime libraries. In addition the Rep Init file contains a function or method, generated by the Rep translator, which creates an array of function pointers or method references of the Node functions defined by the developer, and passes the reference of the array back to the Rep runtime, so that the Rep runtime can gain access to the Node functions.

In addition the Rcp translator will also translate the embedded Rcp statements in Rcp program files as host language calls into Rcp runtime libraries, and produces host language program files 0808.

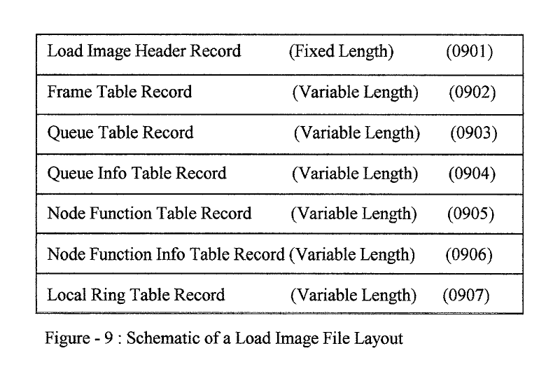

FIG. 09, depicts the internal structure of the Rcp load image file, which comprises of:

1) A Load image header record 0901, of fixed length.

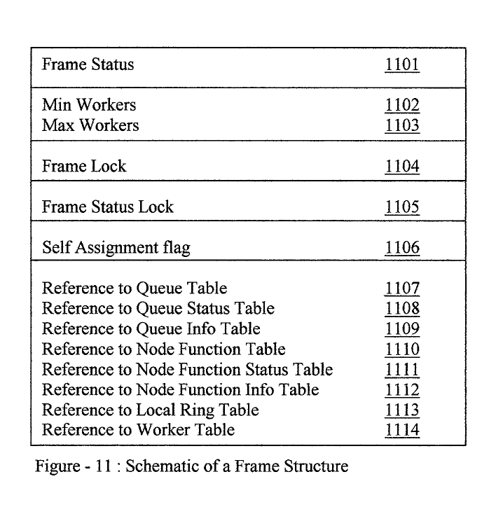

2) A Frame table record 0902 of variable length, which contains the frame resource definitions, in binary format. Each entry in the Frame table is called a Frame structure. FIG. 11, depicts the layout of the Frame structure. The Rcp runtime loads the frame table record 0902, from the Rcp load image file to the Frame table 0104. The index of the Frame table entry is called the Frame number.

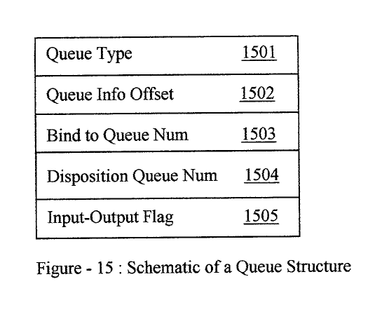

3) A Queue table record 0903 of variable length, which contains the queue resource definitions, in binary format. Each entry in the Queue table is called a Queue structure. FIG. 15, depicts the layout of the Queue structure. Each queue structure is the result of translation of the definition of the queue, queue array, or virtual queue resource. The Rcp runtime loads the queue table record 0903 from the Rcp load image file to the Queue table 0105. The index of the queue table entry is called the queue number, queue array number, or virtual queue number depending on the type of the queue. The Rcp runtime loads the queue table record 0903, from the Rcp load image file to the queue table 0105.

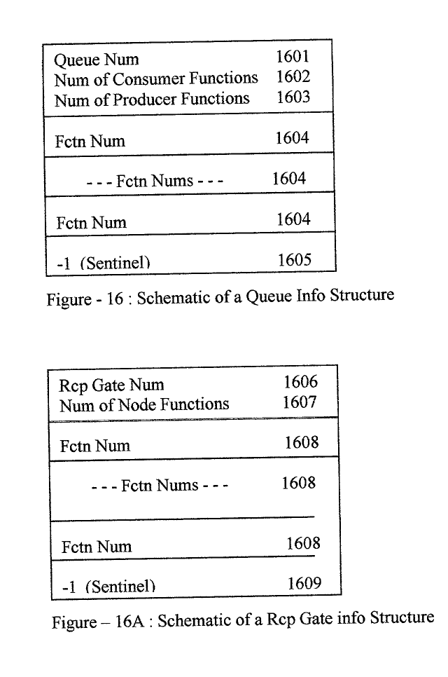

4) A Queue info table record 0904 of variable length, which contains the queue resource definitions, and the node functions utilizing the queue resources, in binary format. Each entry in the Queue info table is called a Queue info structure. FIG. 16, depicts the layout of the Queue info structure. The queue info structure is of variable length, and the offset of the queue info structure in the queue info table is stored in the queue info offset 1502 of the queue node structure FIG. 15, of the queue table entry. The Rcp runtime loads the queue info table record 0904, from the Rcp load image file to the Queue info table 0106.

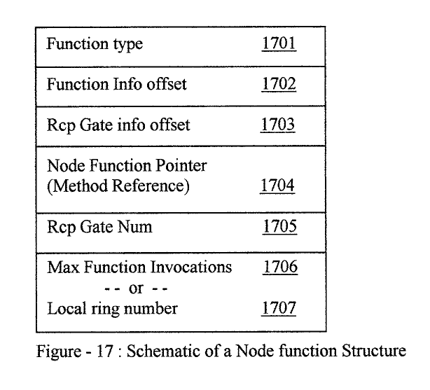

5) A Node function table record 0905 of variable length, which contains the Node function resource definitions, in binary format. Each entry in the Node function table is called a Node function structure. FIG. 17, depicts the layout of the Node function structure. Each node function structure is the result of translation of the definition of the node function, or Rcp gate resource. The Rcp runtime loads the node function table record 0905, from the Rcp load image file, to the node function table 0108. The index of the node function table entry is called the node function number or Rcp gate number depending on the type of the node function. The Rcp runtime loads the node function table record 0905, from the Rcp load image file to the node function table 0108.

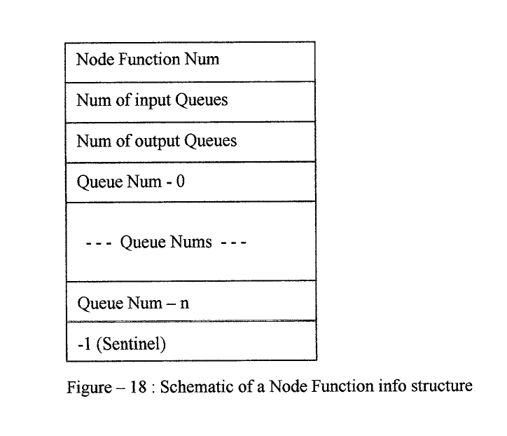

6) A Node function info table record 0906 of variable length, which contains the node function resource definitions, and the queue/queue array/virtual queue resources utilized by the Node function, in binary format. Each entry in the Node function info table is called a Node function info structure. FIG. 18, depicts the layout of the Node function info structure. The Node function info structure is of variable length, and the offset of the node function info structure in the node function info table is stored in the function info offset 1702 of the node function structure FIG. 17, of the node function table entry. The Rcp runtime loads the node function info table record 0906 from the Rcp load image file to the node function info table 0109.

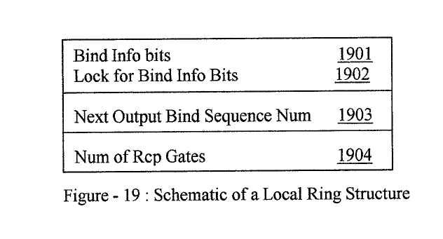

7) A Local ring table record 0907 of variable length, which contains control information for the Rcp Gate resource definitions, in binary format. Each entry in the Local ring table is called a Local ring structure. FIG. 19, depicts the layout of the Local ring structure. The Rcp runtime loads the local ring table record 0907 from the Rcp load image file to the local ring table 0111. The index of the local ring table entry is called the local ring number.

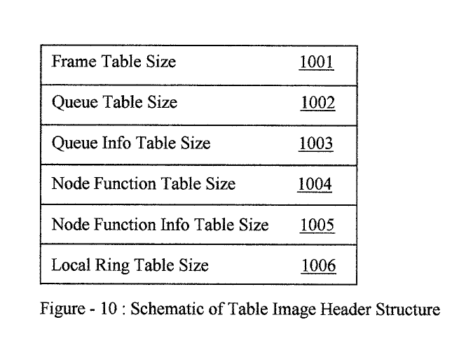

The internal structure of load image header record 0901, is depicted in FIG. 10, and contains, the Frame table record size 1001, the Queue table record size 1002, the Queue info table record size 1003, the Node function table record size 1004, the Node function info table record size 1005, and the local ring table record size 1006. It may be noted that the load image header record 0901, is the first record in the Rcp load image file, and contains the lengths of the variable length load image records following it, so that the Rcp runtime can retrieve the variable length records using the record lengths.

Besides the control tables generated by the Rcp Translator 0803, the Rcp runtime library 0102, creates a queue status table 0107, and a Node function status table 0110, for each of the frames, for storing status and Runtime information of the queues and the node functions. In addition a worker table 0112 is created for each frame by the Rcp runtime library 0102.

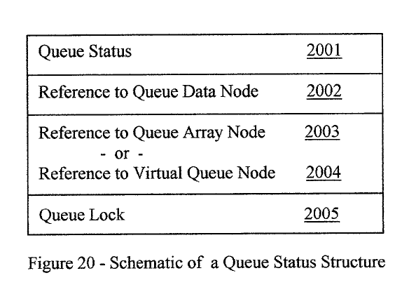

Each entry in the Queue status table 0107, is called a Queue status structure. FIG. 20, depicts the layout of the Queue status structure. For each entry in the queue table 0105, there exists a corresponding entry in the queue status table 0107 at the same index location, as that of the entry in the queue table. For example, the 1^{st}, 2^{nd}, and 3^{rd} entries in the queue table 0105 correspond to the 1^{st}, 2^{nd}, and 3^{rd} entries in the queue status table 0107, and so on.

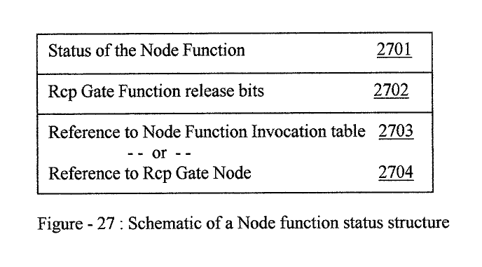

Each entry in the Node function status table 0110, is called a Node function status structure. FIG. 27, depicts the layout of the structure. For each entry in the Node function table there exists a corresponding entry in the node function status table at the same index location, as that of the entry in the node function table. For example, the 1^{st}, 2^{nd} and 3^{rd} entries in the Node function table correspond to the 1^{st}, 2^{nd}, and 3^{rd} entries in the Node Function status table, and so on. Node function status table is shared by node functions and Rcp gates, and the function type field 1701 of the node function structure FIG. 17, determines whether the structure is for Node function or Rcp gate as explained previously.

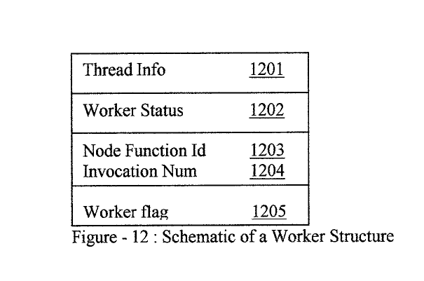

Each entry in the worker table 0112, is called a worker structure. FIG. 12, depicts the layout of the worker structure.

The frame structure of FIG. 11, comprises of:

1) A Frame status field 1101, indicating the current status of the Frame.

2) A Min Workers field 1102, which contains the minimum number of workers defined for the frame. This field is not used in the current Rcp implementation.

3) A Max Workers field 1103, which contains the maximum number of workers defined for the frame. This field is used to create the workers. It may be noted that the frame table image loaded from the Rcp load image file, has this field set to the value defined in the Rcp statement “Define Workers”.

4) A frame lock field 1104, for locking the frame. The frame is responsible for assigning the work to the workers, but since the frame is a passive entity, the work is performed by one of its idle workers, which has acquired the frame lock, and this worker is referred to as a dispatcher for the frame. The dispatcher executes dispatch routines of the Rcp runtime, to assign work to itself and to the other workers in the frame.

5) A frame status lock field for controlling update access to the frame status 1101 of the frame.

6) A Self assignment flag 1106, which indicates whether the dispatcher assigned work to itself. The dispatcher will always assign work to itself prior to assigning work to other workers.

7) A reference (pointer) to each of the tables loaded from the Rcp load image file into the shared memory, is stored in the frame structure, of all the frames. These tables are static in nature and are shared by all the frames. Specifically, the queue table reference is stored in a reference to queue table field 1107, and the queue info table reference is stored in a reference to queue info table field 1109, and the node function table reference is stored in a reference to node function table field 1110, and the node function info table reference is stored in a reference to node function info table field 1112, and the local ring table reference is stored in a reference to local ring table field 1113.

8) The reference to queue status table, and node function status table created for the frame, are stored in the frame structure. Specifically the reference to the queue status table is stored in a reference to queue status table field 1108, and the reference to the node function status table is stored in a reference to node function status table field 1111.

9) A reference to the Worker table created by the Rcp runtime, using the max workers field 1103, is stored in a reference to Worker table field 1114.

The worker structure of FIG. 12, comprises of:

1) A Thread information structure 1201, for storing the reference and identification fields returned by the host language or operating system, when the thread is created.

2) A worker status 1202 field for storing the worker status. Valid values are READY and RUNNING.

3) A node function number field 1203, for which the worker is assigned.

4) An Invocation number field 1204, which contains the invocation number of the node function, for which the worker is assigned.

5) A Worker flag field 1205, which is used to store the STOP or TERMINATE codes when a STOP or TERMINATE Rcp statements are issued, by the node function invocation, for which this worker is assigned.

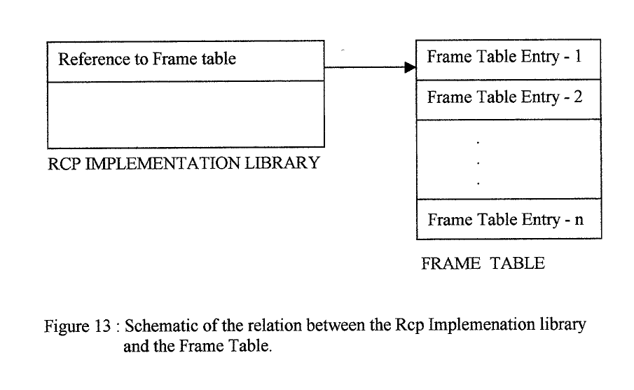

FIG. 13, contains a schematic which explains the relation between Rcp runtime library and the frame table. The Rcp runtime library stores the reference to the frame table 0104, created while loading the Rcp control tables 0103, from the load image file.0806 created by the Rep translator 0803.

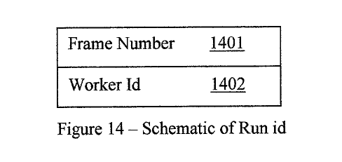

The Rep runtime library 0102 invokes the node functions when the inputs and outputs become available, and passes a special structure called Run identification (Run Id), to the node function. The structure of the Run identification, is depicted in FIG. 14, and comprises of:

1) The frame identification number, which identifies the frame in which the node function is about to execute.

2) The worker identification number, which identifies the worker, which is about to execute the node function.

The only difference between the node function and other user functions is that the node function has a predefined function signature (defined by the Rep architecture), and accepts the Run_id as input (formal function parameter), and returns an integer.

It may be noted that the invocation number is a logical entity from the perspective of the developer. Since the node functions are reentrant by definition, they can be executed concurrently, by multiple workers and from the perspective of the Rep runtime library the invocation number is a real entity, and the Rep runtime library manages the node function invocations.

The Queue structure depicted in FIG. 15, comprises of:

1) A queue type field 1501, for storing the type of the queue. The valid types are INPUT, INPUT_OUTPUT, INPUT_ARRAY, 10_ARRAY, VIRTUAL_INPUT, VIRTUAL_{—}10.

2) A queue info offset field 1502, which contains the offset of the queue info record, in the queue info table 0106.

3) A Bind to queue number field 1503, which is used by the virtual queues to refer to the queue number or queue array number.

4) A Disposition queue num field, which contains the queue number or queue array number to which the contents of the queue will be copied when the queue is consumed by all the consumers. In the case of queue arrays, the queue being deleted, is copied to one of the available queues of the disposition queue array.

5) A Input-Output flag field 1505, which is used by the virtual queues. This field is used to determine whether the virtual queue is defined on the input side of the node function (value 1), or on the output side of the node function (value 2), instead of searching the queue info record.

The queue info structure depicted in FIG. 16, comprises of:

1) A queue num field 1601, to identify the queue. This field is included for safety and is mostly used for debugging purposes.

2) A num of consumer functions field 1602. For virtual queues this field contains the number of node functions acting as a consumer. For real queues or queue arrays, this field contains the number of Rcp gates using the queue or queue array as a consumer. It may be noted that the consumer count for virtual queues is always 1, and has very little use, and the queues contained in the queue array share the same queue info as that of the queue array.

3) A num of producer functions field 1603. For virtual queues this field contains the number of node functions acting as a producer. For real queues or queue arrays, this field contains the number of Rcp gates using the queue or queue array as a producer. It may be noted that the producer count for virtual queues is always 1, and has very little use, and the queues contained in the queue array share the same queue info as that of the queue array.

4) A list 1604 of node function numbers or Rcp gate numbers.

5) A sentinel 1605 containing the value −1, to delimit the list 1604.

The Rcp Gate info structure FIG. 16A, comprises of:

1) A Rcp gate number field 1606, to identify the Rcp gate number. This field is included for safety and is mostly used for debugging purposes.

2) A Number of node functions field 1607, which contains the number of node functions controlled by the Rcp Gate.

3) A list 1608 of node functions controlled by the Rcp gate

4) A sentinel 1609 containing the value −1, to delimit the list 1608.

The node function structure FIG. 17, comprises of:

1) A function type field 1701, which indicates whether the node function table entry is for node function or Rep Gate. Valid values are NODE_FUNCTION or RCP_GATE.

2) A function info offset field 1702, which contains the offset of the node function info record, in the node function info table 0109.

3) A Rep gate info offset field 1703, which contains the offset of the Rcp gate info record located in the queue info record. It may be noted that the Queue info table 0106 is used both by queues and Rcp Gates. The Rcp Gates store the list of node functions they are controlling in the queue info table. It may be noted that the Rcp gate controls only one node function, but this design provides the flexibility where the rcp gates can control more than one node function.

4) A Node function pointer or method reference field 1704. For the node function this field contains the pointer to the node function. For the Rcp Gate this field contains the pointer to a function called Rcp Gate Proc. Rcp Gate proc's are not used.

5) A Rcp Gate number field 1705, which contains the Rcp Gate number for the node function. This field is not used by the Rcp gates.

6) A Max Function invocations field 1706, which contains the maximum number of invocations the node function can have.

7) A local ring number field 1707, which contains the local ring number to which the Rcp gate number is connected. It may be noted that Max function invocations field 1706, and the local ring number field 1707 share the same field of the node function structure.

The node function info structure FIG. 18, comprises of:

1) A Node function number field 1801, to identify the node function. This field is included for safety and is mostly used for debugging purposes.

2) A Num of input queues field 1802, which contains the number of virtual queues defined on the input side of the node function or the number of queues and queue arrays defined on the input side of the Rcp gate.

3) A Num of output queues field 1803, which contains the number of virtual queues defined on the output side of the node function or the number of queue arrays defined on the output side of the Rcp gate.

4) A list 1804 of virtual queue numbers, or queue numbers and queue array numbers.

5) A sentinel 1805 containing the value −1, to delimit the list 1804.

The local ring structure in FIG. 19, comprises of:

1) A Bind info bits field 1901, for storing the bind information. Each bit in the bind info bits field 1901, corresponds to the queue index of the queue arrays defined on the output side of the Rcp gate. A value of 1 in the bind info bit indicates that the corresponding output queue index is currently in use, whereas a value of 0, in the bind info bit indicates that the corresponding output queue index is available for use. The initial value is zero.

2) A lock for bind info bits field 1902, which is used to access the bind info bits 1901. The initial value of this field is zero.

3) A Next output bind sequence number field 1903, which contains the next sequence number that would be allocated to the next available output queue set identified by the queue index of the queue arrays defined on the output side of the Rcp gate. The initial value is 1.

4) A Num of Rcp Gates field 1904, which contains the num of Rcp gates connected to the local ring. The value is determined by the Rcp Translator during translation.

The queue status structure FIG. 20, is used by queues, queue arrays, and virtual queues, and the structure comprises of:

1) A queue status field 2001 for maintaining the status of the queue.

a) For queues, the status field has values of READY, and NOT_READY.

b) For queue arrays the status field is set to READY upon creation. Valid values are READY and NOT_READY.

c) For virtual queues the status field is always set as VIRTUAL.

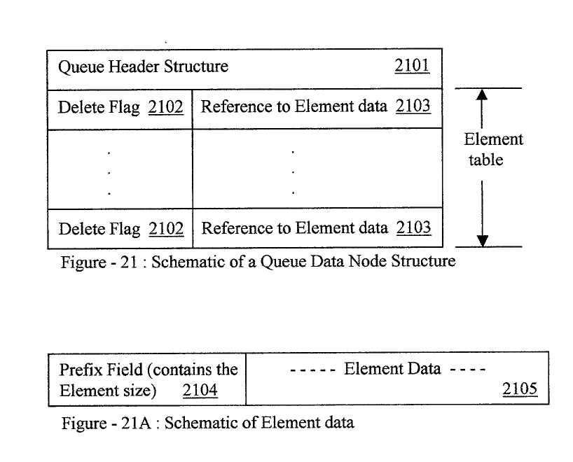

2) A reference to a Queue data node 2002. FIG. 21, depicts the structure of the queue data node. The queue data node is used only by queues and queue arrays, and contains control information and data of the queues and queue arrays.

3) A reference to a special structure depending on whether the Rcp resource is the queue array or the virtual queue, as explained below:

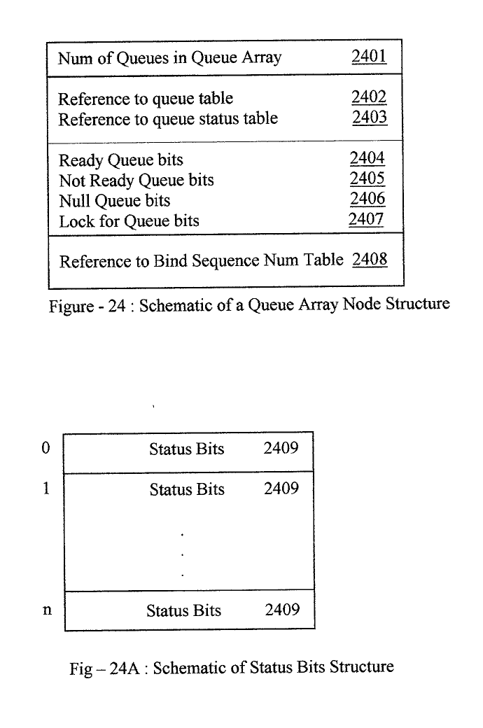

a) For queue arrays, a reference to a Queue array node 2003 is stored in this field. FIG. 24, depicts the structure of the queue array node.

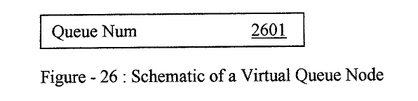

b) For virtual queues, a reference to a Virtual queue node 2004 is stored in this field. FIG. 26, depicts the structure of the virtual queue node.

4) A queue lock field 2005, for locking the queue data node, referenced by 2002.

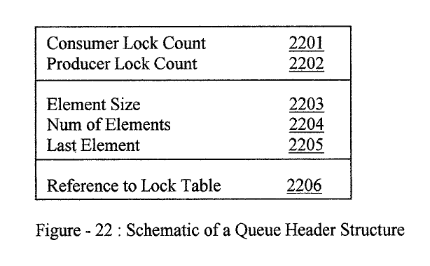

The queue data node FIG. 21, comprises of a queue header structure and queue data. The queue header structure is depicted in FIG. 22, and comprises of:

1) A consumer lock count field 2201, which contains the number of consumers currently using the queue, or queue array.

2) A producer lock count field 2202, which contains the number of producers currently using the queue array. The producer lock count field 2202 is used only by queue arrays.

3) An element size field 2203, which contains the size of each element.

4) A number of elements field 2204, which contains the number of elements.

5) A last element field 2205, which contains the last element created.

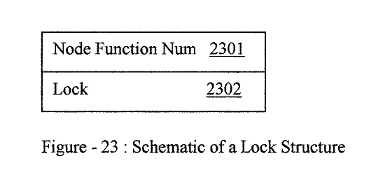

6) A reference to a lock table 2206. The lock table is used by queues of type input-output, to lock the elements of the queue. Each entry in the lock table is called a lock structure. FIG. 23, depicts the lock structure. For each element in the queue, there exists an entry in the lock table, which contains a lock structure, at location identified by the element number.

The lock structure in FIG. 23, comprises of:

1) A node function number field 2301, which contains the node function number which locked the element.

2) A lock field 2302, which is used for setting the lock on the element.

The queue array node structure in FIG. 24, comprises of:

1) A number of queues in queue array field 2401, which contains the number of queues in the queue array.

2) A reference to an internal queue table 2402, which contains a reference to an internally created queue table. This queue table has the same layout as the queue table 0105 contained in the frame, and the entries in the queue table have the same structure as the queue structure described earlier in FIG. 15.

3) A reference to an internal queue status table 2403, which contains a reference to an internally created queue status table. This queue status table has the same layout as the queue status table 0107 contained in the frame, and the entries in the queue status table have the same structure as the queue status structure described earlier in FIG. 20.

4) A ready queue bits field 2404 of type status bits, described in FIG. 24A, which contains a bit indicating whether a queue contained in the queue array is ready (set to 1), or not ready (set to 0). The index of the queue contained in the queue arrays internal queue table 2402, is used to determine the location of the bit in the ready queue bits field 2404.

5) A not ready queue bits field 2405 of type status bits, which contains a bit indicating whether a queue contained in the queue array is not ready (set to 1), or ready (set to 0). The index of the queue contained in the queue arrays internal queue table 2402, is used to determine the location of the bit in the not ready queue bits field 2405.

6) A null queue bits field 2406 of type status bits, which contains a bit indicating whether a queue contained in the queue array is null (set to 1), or not null (set to 0). The index of the queue contained in the queue arrays internal queue table 2402, is used to determine the location of the bit in the null queue bits field 2406.

7) A lock field 2407, for locking access to the ready queue bits 2404, not ready queue bits 2405, and null queue bits 2406.

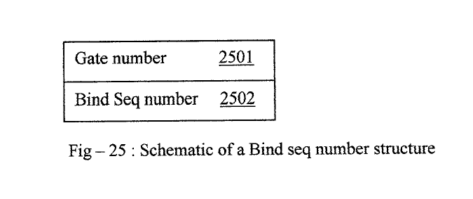

8) A reference to a Bind seq num table field 2408. Each entry in bind seq num table is called a Bind seq num structure. FIG. 25, depicts the structure of the Bind seq number. For each queue contained in the queue array there exists a bind seq num entry in the bind seq num table, at the location identified by the index of the queue in the internal queue table 2402, of the queue array. The status bits structure in FIG. 24A comprises of:

1) An array of bytes or words 2409, of the underlying memory, organized as a group, such that the individual bits of the group are considered to be in a sequential order. The bits of the group are numbered from right to left, and top to bottom, starting from zero.

The bind seq num structure, in FIG. 25 comprises of:

1) A Rcp gate num field 2501, which contains the Rcp gate num which bound the queue.

2) A Bind seq number field 2502, which contains a unique sequence number assigned by the Rcp gate, to each output queue set bound to the node function invocation.

The virtual queue node in FIG. 26, comprises of:

1) A queue number field 2601, which is used to store the index number of the queue stored in the queue array, to which the virtual queue is bound. This field is not currently used.

The Node function status structure, in FIG. 27, comprises of:

1) A Node function status field 2701, which contains the status of the node function. The node function status is always set to VIRTUAL, when the node function is connected to the Rcp gate. The status has no meaning since multiple invocations may exist for the node function.

2) A Rcp Gate function release bits field 2702, which is used only by Rcp Gates. It may be noted that some of the Rcp Gates in every application will not have any input queue arrays. These Rcp gates are called top level Rcp Gates, and the node functions controlled by them are called top level node functions. Top level node functions have the independence to decide when the node function must terminate. The node functions may express their intention to terminate, by the Rcp statement “Release Qeueus”. Only top level node functions which are not dependent on any inputs (queues or queue arrays), may issue this statement. When a Node function invocation issues the “Release queues” statement, the Rcp gate resets a bit in the Rcp Gate function release bits field 2702. When all the bits in the Rcp gate function release bits are reset, the field value equals zero, and the Rcp gate realizes that all the node function invocations have terminated and will terminate itself, paving the way for other lower level Rcp gates to terminate.

3) A reference to a special structure depending on whether the Rcp resource is the node function or the Rcp Gate, as explained below:

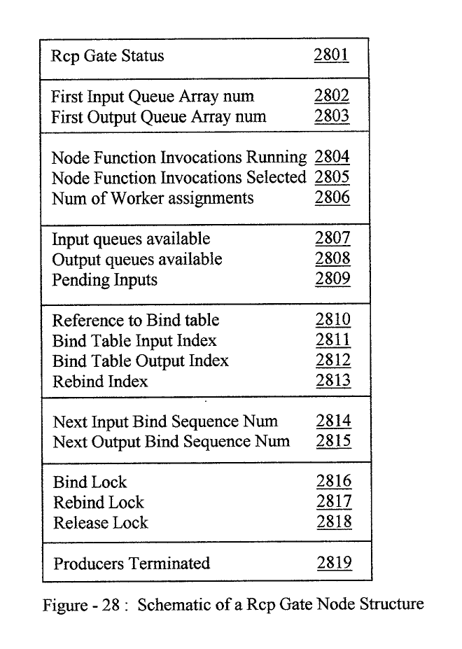

a) For rcp gates, A reference to a Rcp Gate node 2704, is stored in this field. FIG. 28, depicts the structure of the rcp gate node.

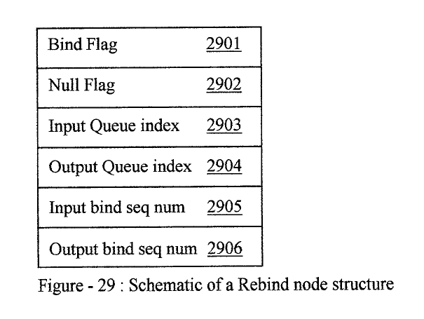

b) For node functions, a reference to a Node function invocation table 2703, is stored in this field. Each entry in the Node function invocation table is called a node function invocation structure. FIG. 29, depicts the node function invocation structure.

The Rcp gate node structure in FIG. 28, comprises of:

1) A Rcp gate status field 2801, containing the current status of the Rcp gate. Valid values are UNINITIALIZED, READY, and TERMINATED.

2) A First input queue array num field 2802, which contains the first queue array num, specified on the input side of the Rcp gate.

3) A First output queue array num field 2803, which contains the first queue array num, specified on the output side of the Rcp gate.

4) A Node Function Invocations Running field 2804, which contains the number of node function invocations currently running.

5) A Node function invocations selected field 2805, which contains the number of node function invocations currently selected for execution by the Rcp gate.

6) A Number of worker assignments field 2806, which contains the number of times a worker is assigned to the node function invocations controlled by the Rcp Gate.

7) An Input queues available field 2807, which contains the number of input queues available for binding to the node functions.

8) An Output queues available field 2808, which contains the number of output queues available for binding to the node function invocations.

9) A pending inputs field 2809, which contains the number of input queues available for binding, but which cannot be bound because of intermediate gaps in the inputs. Gaps in the inputs means some of the bind seq numbers are missing. For example, if the inputs have the following bind seq numbers, 1,2,3,5,6,7 then input queues available are only 3, since we are missing the 4th bind seq number from inputs. Bind seq numbers 5,6, and 7 are available before 4^{th} bind seq num became available, hence 5,6, and 7 bind seq numbers are classified as pending inputs, and in this case their count is 3, which will be stored in the pending inputs field 2809.

10) A reference to a Bind table field 2810. Each entry in the bind table is called a bind node. FIG. 29, depicts the structure of the bind node. The bind table is the heart and core of the Rcp gate. The bind table has a fixed number of entries, usually equal (at least), to the maximum number of queues the queue array can contain. Please refer Appendix-B for more information on bind table.

11) A Bind table input index field 2811, which contains an index of the Bind table, where the next input binding is expected.

12) A Bind table output index field 2812, which contains an index of the Bind table, where the next available output queue set will be bound.

13) A rebind index field 2813, which contains an index of the Bind table, which is the next Bind seq number to be processed by the node function invocations.

14) A Next input bind seq num field 2814, which contains the next input bind seq num expected, by the rcp gate.

15) A Next output bind seq num field 2815, which contains the next output bind seq num, that might be assigned to the output queue.

16) A Bind lock field 2816, which is used by the Bind_Virtual_Queues function 3207, to prevent concurrent access to the shared fields used by the function.

17) A rebind lock field 2817, which is used by the Rebind_Virtual Queues function 3208 to prevent concurrent access to the shared fields used by the function.

18) A release lock field 2818, which is used by the Release_Queues function 3112, to prevent concurrent access to the shared fields used by the function.

19) A producer terminated field 2819, which is used to indicate that producers for at least one of the input queue array have terminated.

The bind node in FIG. 29, comprises of:

1) A Bind flag field 2901, which indicates the current status of the bind table entry. Valid values and their meanings are described below:

| Bind Flag Value | Remarks |
|---|---|
| 0 | The bind table entry is free. |
| 1 | The inputs have arrived but are pending. |
| 2 | The inputs have arrived, and are available |
| 3 | The outputs are available. |
| 4 | The inputs have arrived but are pending, |
| | and the outputs are available. |
| 5 | The inputs have arrived, and are available, and |
| | the outputs are available. |
| 6 | The bind table entry is currently in use by a |
| | node function invocation. |

2) A Null flag field 2902, which indicates if the current inputs are null.

3) An input queue index field 2903, which contains an index number. The queue located at this index number, in each of the input queue arrays is available for binding to an invocation of the node function.

4) An output queue index field 2904, which contains an index number. The queue located at this index number, in each of the output queue arrays is available for binding to an invocation of the node function.

5) An input bind seq num 2905, which contains the bind seq number of the input. This field is mainly used for debugging purposes.

6) An output bind seq num 2906, which contains the bind seq number of the output.

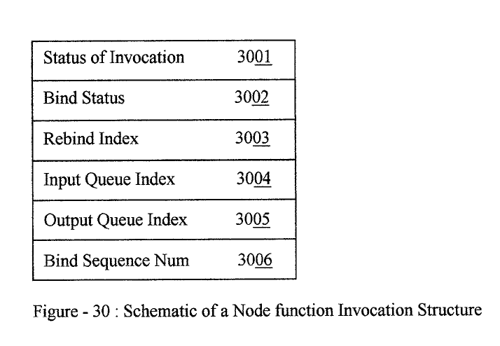

The node function invocation structure in FIG. 30, comprises of:

1) A Status of Invocation field 3001, which contains the status of the node function invocation. Valid values are READY, RUNNING, WAITING_FOR_DISPATCH, and TERMINATED.

2) A Rebind status field 3002, which contains the status of the last rebind statement, issued by the node function invocation.

3) A Rebind index field 3003, which contains the index of the bind table entry, which is used to bind the queues to the node function invocation.

4) An input queue index field 3004, which contains an index number. The queue located at this index number, in each of the input queue arrays is bound to the invocation, of the node function.

5) An output queue index field 3005, which contains an index number. The queue located at this index number, in each of the output queue arrays is bound to the invocation, of the node function.

6) A Bind seq number field 3006, which contains the output bind seq number assigned by the Rcp gate.

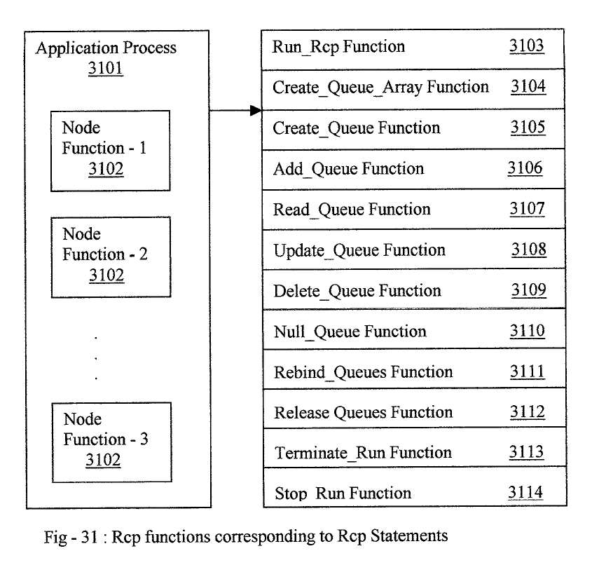

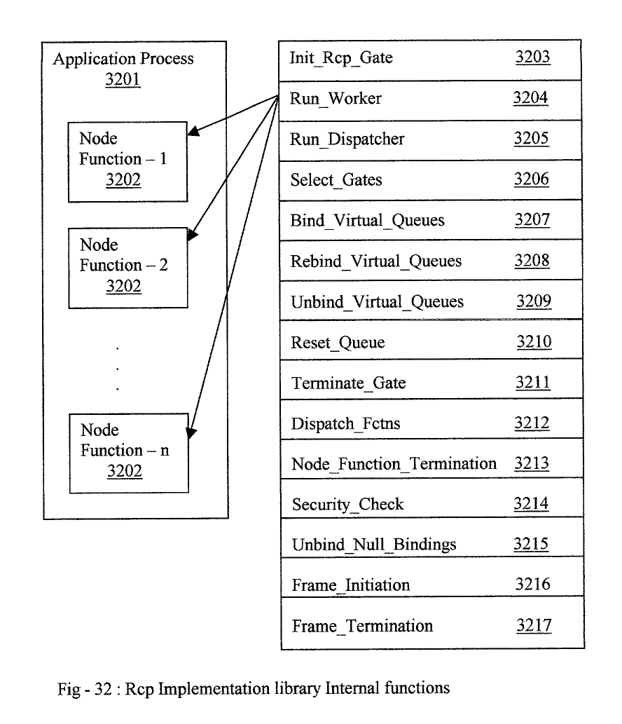

FIGS. 31 and 32, depicts the routines contained in the Rcp runtime libraries. Each Rcp statement has a corresponding routine in the Rcp runtime library. In addition the Rcp runtime has routines for Initialization, Frame startup, Frame termination, worker management, dispatching, Node function termination, unbinding queues bound to node functions, and helper routines to print error messages.

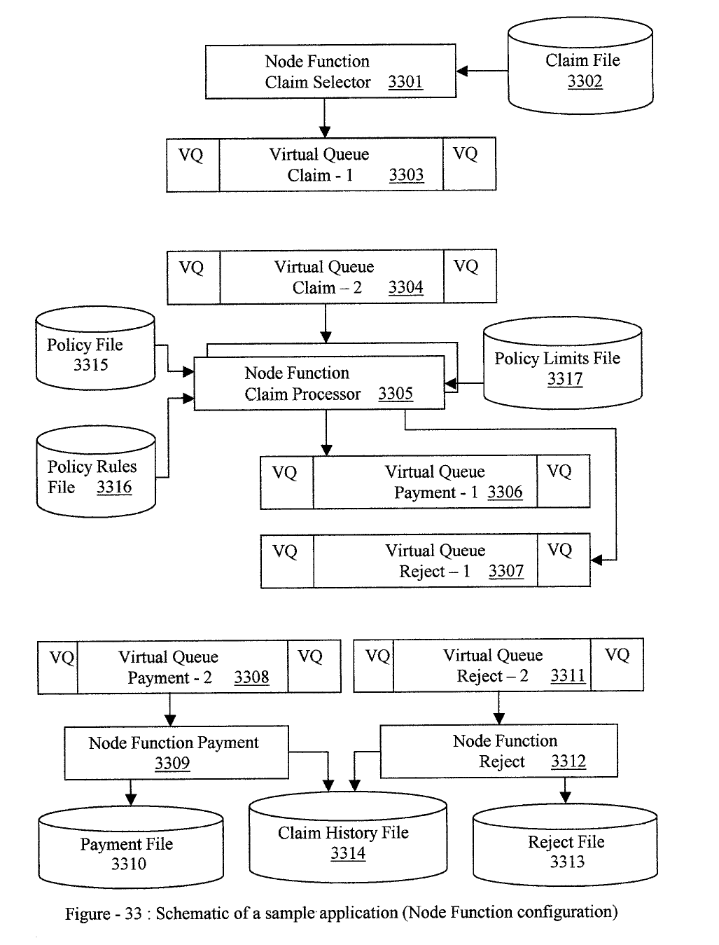

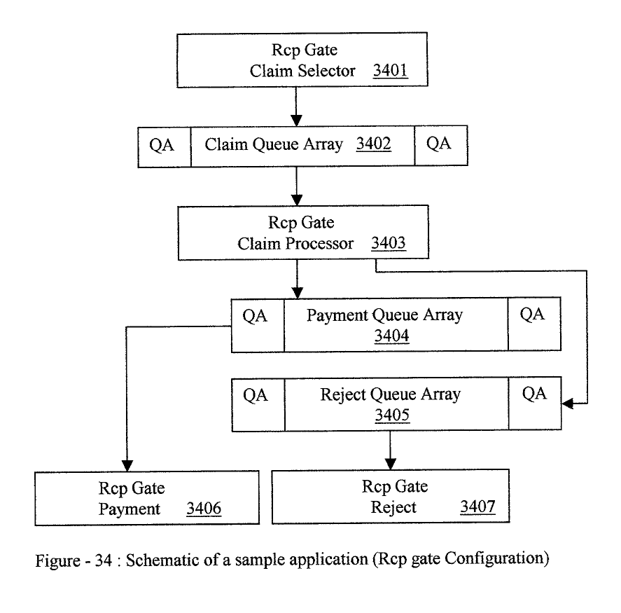

FIGS. 33, and 34 depict a sample application configuration. The purpose of the sample application is to read claim records from a data file called claim data file and process the claim records read, where it is determined whether the claim record read should be paid, or rejected, based on the maximum limits for number of claims and amount, which can be paid for a policy.

The sample application utilizes the following data files, and the layouts of these data files are depicted in Appendix-F

1) A claim file which contains the claims to be processed

2) A policy file which contains policy details.

3) A policy rules file which contains the maximum amount a claim type can be paid, in a calendar year.

4) A policy limits file, which contains the amount paid for previous claims in a calendar year.

5) A history file, to which the claim details are written as history.

6) A Reject file which contains the rejected claim records

7) A Payment file which contains the claims cleared for payment.

The configuration in FIG. 33, comprises of:

1) A Node function claim selector 3301, which reads claims from the claim file 3302, and writes the claims to the queue referred by a virtual queue called claim—1 3303. It may be noted that Rcp architecture considers only Rcp resources like queues, queue arrays and virtual queues as inputs or outputs. The node functions may use other inputs and outputs like files, which are not related to the Rcp architecture. The claim record read contains claim information like, claim number, policy number, and claim amount.

2) A Node function claim Processor 3305, which reads the claims via a virtual queue called claim—2 3304, and writes the output of the processing to either a virtual queue called Payment—1 3306 or a virtual queue called Reject—1 3307. The node function claim processor 3305, uses the files Policy file 3315, Policy rules file 3316, and Policy limits file 3317.

3) A Node function Payment 3309, which reads the claims cleared for payment, via a Virtual queue Payment—2 3308, and writes output records to the Payment file 3310, and the history file 3314.

4) A Node function reject 3312, which reads the claims rejected for payment via a Virtual queue Reject—2 3311, and writes output records to the reject file 3313, and the history file 3314.

The configuration in FIG. 34, comprises of:

1) A Rcp gate named claim Selector 3401, which manages the node function claim selector 3301, and an output queue array called claim queue array 3402.

2) A Rcp gate named claim Processor 3403, which manages the node function claim processor 3305 and its two invocations, and the claim queue array 3402 as input queue array, and two output queue arrays called Payment queue array 3404, and Reject queue array 3405.

3) A Rcp gate named Payment 3406, which manages the node function Payment 3309, and the Payment queue array 3404, as input queue array.

4) A Rcp gate named Reject 3407, which manages the node function Reject 3312, and the Reject queue array 3404, as input queue array.

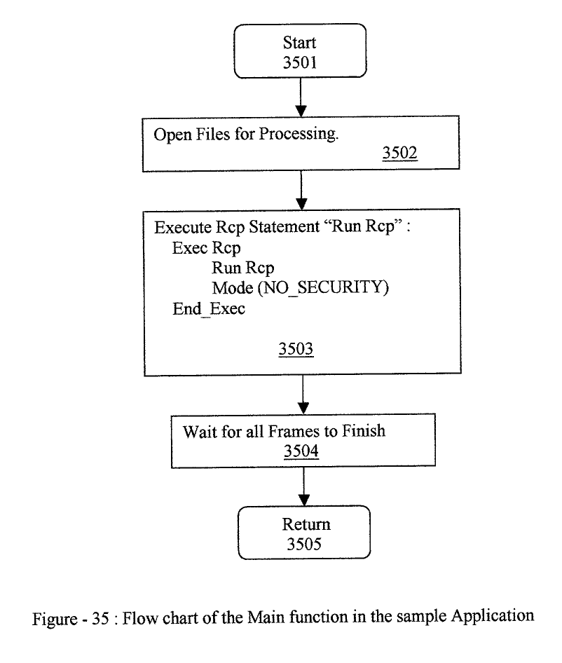

The flow charts for the Sample application are provided in FIGS. 35 thru 39.

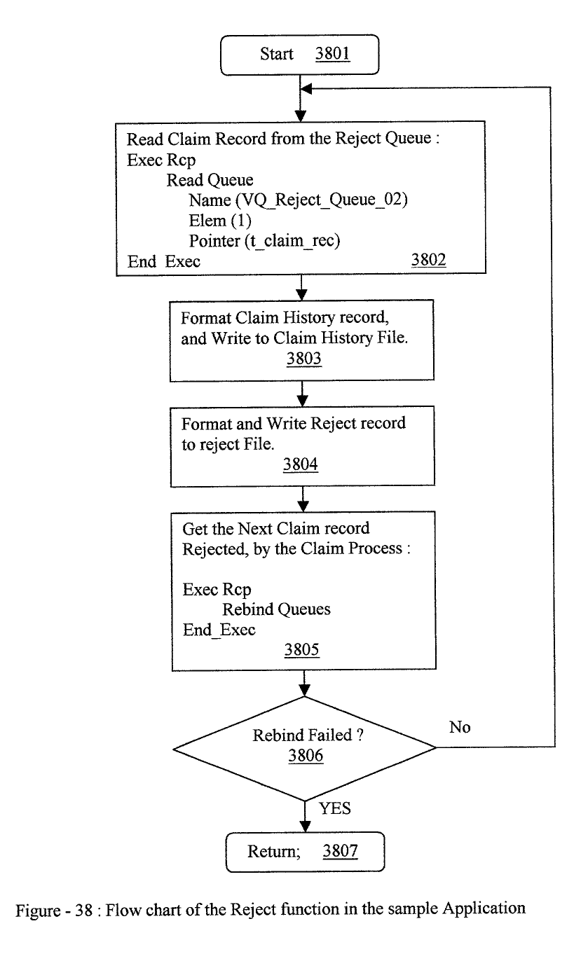

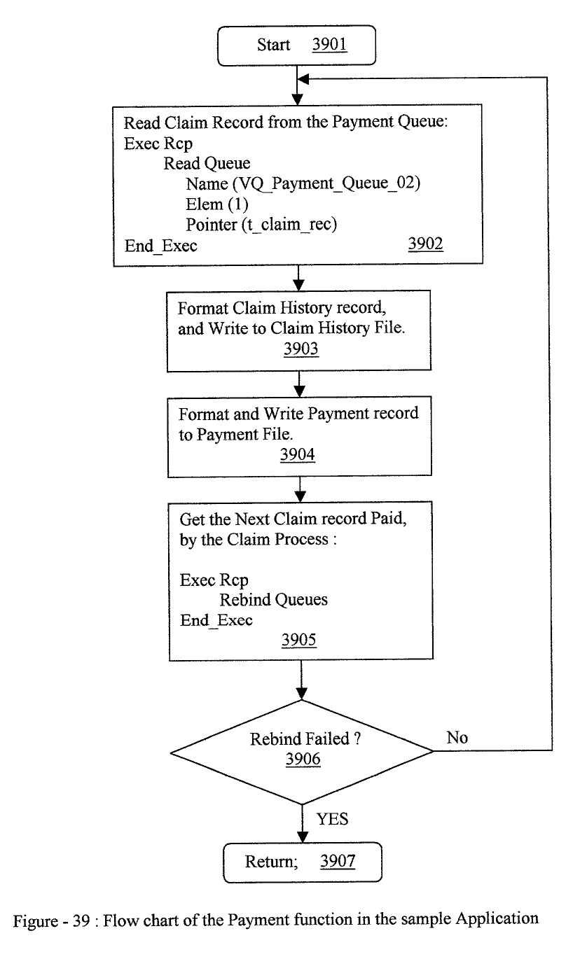

Operation—FIGS. 1-39, and FIGS. 40-48

The operation of the invention is divided into three parts:

a) Operation of the Rcp translator, and preparation of the sample application.

b) Operation of the Rcp runtime library.

c) Operation of the sample application, utilizing the Rcp runtime library.

a) Operation of the Rcp Translator, and Preparation of the Sample Application:

The preparation of the sample application comprises of parsing the declarative Rcp Statements in the resource definition file, and optionally parsing the executable Rcp statements in the program files. It may be noted that the declarative Rcp statements have to be parsed by the Rcp translator, where as executable Rcp statements can be specified as host language statements, to avoid parsing.

The Rcp translator reads the resource definition file, and generates the queue symbol table by loading the queue, queue array and virtual queue definitions in the queue symbol table. Similarly the node function definitions and the Rcp Gate definitions are loaded into the node function symbol table. It may be noted that the Rcp Gate definitions are loaded before the node function definitions in the node function symbol table.

The node function info table is constructed from the Node function definitions and Rcp Gate definitions, as both these statements have QLIST1 and QLIST2 parameters which specify the input queues or queue arrays and output queues or queue arrays respectively.

The queue info table is generated from the queue symbol table and the function info table, as explained below. For each entry in the queue symbol table, the input queues of every function or, Rcp Gate are searched in the function info table, when an entry is found, the function number is recorded in the queue info table. The number of functions found at the end of the search give the consumer count for the queue, queue array or virtual queue. Similarly for each queue in the queue symbol table, the output queues of every function or, Rcp gate are searched in the function info table, when an entry is found, the function number is recorded in the queue info table. The number of functions found at the end of the search give the producer count for the queue, queue array or virtual queue.

The local ring table is built as explained below. For each Rcp gate in the node function table, the local ring num is examined, if a local ring num is already allocated, the Rcp gate is skipped and the next rcp gate is selected. If a local ring num is not already allocated, a new local ring num is allocated for the Rcp Gate, and the output queue arrays of the Rcp gate are stored in a temporary buffer. For each queue array in the temporary buffer, the output queues of every other Rcp gate are searched by walking through the function info table entries of the Rcp Gates.

If a match is found, the current local ring number is assigned to the matching Rcp Gate, and each of the output queue arrays of the matching Rcp Gate are retrieved and a search is made in the temporary buffer to check if the queue array is already in the temporary buffer, if found the queue array is ignored, if not found, the queue array is added to the temporary buffer. This operation is continued until the end of the temporary buffer is reached. The operation is repeated with the next Rcp gate, until all Rcp gates are exhausted. It may be noted that each Rcp Gate is assigned a local ring even if there are no collisions. In the case of no collisions, the Rcp gate will be the only one using the local ring.

The local ring table is built based on the local ring structure FIG. 19, and the number of local rings obtained above. Each entry in the local ring table is initialized as explained below.

The Bind info bits field 1901, of the local ring structure FIG. 19, is set to zero. The lock for bind info bits field 1902, is set to zero. The next output bind seq num field 1903, is set to 1. A search is performed across all the rcp Gates in the node function table, and the count of the Rcp gates using the current local ring is obtained, and stored in the Num of Gates field 1904, of the local ring structure. This completes the build of the local ring table.

The Frame table is created based on the number of frames specified in the “Create Frames” Rcp Statement. The only value stored in the frame table entries is the maximum workers count obtained from the “Create Workers” Rcp statement.

The load image tables are generated as follows. A new copy of the load image header structure FIG. 10, is created in memory. The sizes of the frame table, queue table, queue info table, node function table, node function info table, and local ring table are copied to the corresponding fields of the load image header structure. The load image header structure is copied as the load image header record 0901, of the load image file 0806. The frame table is copied as is to the load image file as frame table load image record 0902. From the queue symbol table 0804, queue table load image 0805 is generated, and is copied to the load image file, as Queue table record 0903. From the node function symbol table 0804, the node function table load image 0805 is generated, and is copied to the load image file as node function table record 0905. The node function info table and queue info table are copied as is to the load image file, as queue info table record 0904, and node function info table record 0906. The local ring table is copied to the load image file as local ring table record 0907.

The translator will generate host language equivalent calls to all the executable Rcp statements. This completes translation.

The program files are compiled, along with the Rcp_jnit file generated by the Rcp translator, and optionally linked with the runtime libraries of the Rcp implementation, and the runtime libraries of the host language, and an executable module is generated.

b) The Operation of the Rcp Runtime Library:

The Rcp runtime library depicted in FIGS. 31 and 32, comprises of a function for each of the Rcp Statements, and functions for dispatching, and managing Workers, functions for Binding queues to Node functions, and other helper functions. The operation of the important functions is explained below:

1) Run_Pgm Function 3103:

The Run_Pgm function 3103 in the Rcp runtime library corresponds to the Run_Pgm statement. The Run_Pgm statement has only one parm, namely Mode (Security mode), but the Run_Pgm function takes more formal parameters which are, statement number, Rcp load image file name, Rcp_jnit function pointer, Rcp_Finish function pointer, and finally the security mode. It may be noted that the Rcp_jnit function pointer points to the Rcp_jnit function generated by the Rcp Translator, and the Rcp Finish function pointer points to a Rcp Finish function, which is called by the Rcp runtime library, when the frames or program terminate. These parameters are automatically generated by the Rcp Translator and the developer has to supply the Rcp Finish function with a predefined signature.

The Run_Pgm function opens the Rcp load image file 0806 and loads the Rcp load image header record 0901, which contains the record sizes of the trailing records. By making use of these record sizes, the frame table record 0902, queue table record 0903, queue info table record 0904, node function table record 0905, node function info table record 0906, and the local ring table record 0907 are loaded from the Rcp load image file into the Rcp control tables 0103.

The Run_Pgm function, executes the Rcp_init function, which passes back an array of pointers to the node functions. These node function pointers are stored in the node function table 0108.

For each entry in the frame table 0104, a copy of the queue status table 0107, and a copy of the node function status table 0110, are created, by making use of the queue table size, and the node function table size. The references to all the tables loaded and created are stored in the frame structure FIG. 11. Each of the Rcp Gates in the node function table, 0108 are initialized, by executing the internal function Init Rcp gate 3203, of the Rcp runtime library.

For each entry in the frame table 0104, a new copy of the worker table 0112 is created, and the reference to the newly created worker table is stored in the Reference to Worker table 1114 of the frame table entry.

The Frame_Initiation function 3216 is executed, which creates the workers by making use of the maximum workers field of the frame structure. The thread information provided by the operating system for each of the workers is stored in the Thread info 1201 of the worker table. The Node function number 1203 of the worker table entry is set to RUN_DISPATCHER, and the worker is started. Each worker executes the Rcp runtime library function called Run_Worker 3204, which manages the workers.

2) Init_Rcp_Gate Function 3203:

The Init_Rcp_Gate function 3203, of the Rcp runtime library is provided to initialize the Rcp gates. This function receives the frame number and the Rcp Gate number as parameters.

The reference to the Rcp Gate node 2704, is retrieved from the node function status table entry indexed by the Rcp Gate number. If the reference to the Rcp Gate node 2704 is NULL, a new copy of the Rcp Gate node structure FIG. 28, is created. The Rcp_Gate status 2801 is set to UNINITIALIZED, and the reference of the newly created Rcp Gate node, is stored in the reference to the Rcp gate node field 2704.

The fields of the Rcp Gate node structure FIG. 28, excluding the Rcp gate status 2801 are initialized as explained below.

The Node Function Invocations Running field 2804, the Node function invocations selected field 2805, and the Num of Worker assignments field 2806 are initialized to zero. The Input queues available 2807, the Output queues available 2808, and the pending inputs 2809, are initialized to zero. The Bind table input index 2811, the Bind table output index 2812, and the rebind index 2813 are initialized to zero. The Next input bind sequence number 2814, and the next output bind sequence number 2815 are set to 1. The bind lock 2816, the rebind lock 2817, and the release lock 2818 are set to zero. The Producers Terminated field 2819 is set to zero.

The Rcp Gate info offset 1703 is retrieved from the node function structure FIG. 17, of the node function table entry indexed by the Rcp gate number. Using the Rcp Gate info offset 1703, the Rcp gate info structure FIG. 16A, is retrieved from the queue info table. The node function number is retrieved from the Rcp gate info structure FIG. 16. It may be noted that the queue info table is used to store the node functions which use the queue, and is also shared by Rcp Gates to store the node function controlled by the Rcp Gates.

The max function invocations field 1706 is retrieved from the node function structure of the node function table entry indexed by the node function number obtained above The Rcp Gate function release bits 2702 field in the node function status structure of the node function status entry indexed by the rcp gate number, is set to 2 power max function invocations field 1706 minus 1.

The function info offset 1702 is retrieved from the node function table entry indexed by the Rcp gate number, and the node function info record structure FIG. 18, is retrieved from the node function info table 0109, using the function info offset 1702. It may be noted Rcp gates and node functions share the node function table 0108, and node function info table 0109. The first input queue array and the first output queue array are determined from the node function info structure by making use of the number of input queues field 1802 and number of output queues field 1803. The first input queue array and first output queue array are copied to the first input queue array number 2802 and first output queue array number 2803 of the rcp gate node structure FIG. 28. If the first input queue array or first output queue array is not defined then −1 is copied to the respective fields 2803, or 2803 of the rcp gate node structure FIG. 28.

A new copy of the Bind table is created by making use of the Bind node structure FIG. 29, and the implementation defined maximum for bind table entries. It may be noted that the implementation defined maximum bind table entries is greater than or equal to the maximum capacity of the queue arrays. The bind node structure FIG. 29, of the bind table entries is initialized as described below.

The bind flag 2901, and the null flag 2902 are set to zero. The input queue index 2903, and the output queue index 2904 are set to −1. The input bind sequence number 2905, and the output bind sequence number 2906 are set to zero.

The reference to the newly created bind table is stored in the reference to the bind table field 2810, of the rep gate node structure FIG. 28.

A new copy of node function invocation table is created using the node function invocation structure FIG. 30, and the max function invocations 1706 retrieved above. The status of invocation 3001 of each invocation is set to READY, and the reference to the newly created node function invocation table is stored in the reference to the node function invocation table 2703 of the node function status table entry indexed by the node function number.

The function info offset 1702 of the node function structure FIG. 17, in the node function table entry indexed by the node function number is retrieved, and the node function info structure FIG. 18, is retrieved from the node function info table 0109. It may be noted that the node function info structure FIG. 18, contains the virtual queues used by the node function. For each of the virtual queues, a new copy of the virtual queue table is created by making use of the virtual queue node structure FIG. 26, and the max function invocations field 1706. The reference to the newly created virtual queue table is stored in the reference to virtual queue table 2004, of the queue status structure FIG. 20, in the queue status table entry indexed by the virtual queue number.

This completes the initialization of the Rcp Gate and the Rcp gate status 2801 is then set to READY, and the Init_Rcp_gate function returns with a successful return code.

3) Run_Worker Function 3204:

The Run_Worker function 3204 of the Rcp runtime library, manages the workers of the frame. Every worker executes this function, at startup. This function receives the Run_id FIG. 14, as a parameter. By making use of the Frame number 1401 contained in the Run_id FIG. 14, each worker gains access to the Frame structure FIG. 11, contained in the frame table entry, at the location identified by the Frame number.

The node function number 1203, of the worker structure FIG. 12 in the worker table entry corresponding to the worker number is retrieved. At startup this contains a special value called RUN_DISPATCHER_FCTN. Each worker individually, attempts to set the frame lock 1104, and only one of the workers in the frame succeeds in this attempt, and that worker can execute the Run Dispatcher function 3205 provided by the Rcp runtime, and is referred as the dispatcher for the frame in which it exists. All other workers of the frame which have failed to set the frame lock 1104, enter an indefinite wait state, until they are signaled by the dispatcher.

After all worker assignments are complete, the worker removes the frame lock 1104, and checks for the self_assignment flag 1106, in the frame structure FIG. 11. If the self_assignment flag 1106, is set to 1, then it retrieves the node function number 1203, from the worker table FIG. 12, and uses it to retrieve the node function pointer 1704, from the node function table, and invokes the node function with the Run_id structure FIG. 14, prepared by combining the frame number and worker id.

After executing the node function, the worker executes the internal function Node_Function_Termination function 3213, of the Rcp Runtime library, after which the worker sets its status field 1202 to READY.

The Run_Worker function 3204, then attempts to set the frame lock 1104, and if successful will execute the Run_Dispatcher function 3205, else it will wait indefinitely for a signal from the dispatcher of the frame.

If no work is found, the dispatcher re executes the Run_Dispatcher function 3205, and these activities are repeated until the Run_Dispatcher function 3205 returns a negative return code, which is one of the following return codes, namely, STOP, IDLE, FRAME_TERMINATED, and PGM_TERMINATED. When any of these return codes are obtained, then the dispatcher terminates the frame, by calling the Frame_Termination 3217 function of the Rcp Runtime library, which assigns a special node function number called EXIT_F UNCTION to all the workers and itself The dispatcher of the frame then executes the Rcp_Finish function, using the function pointer or method reference of the Rcp Finish function, received from the Run_Pgm function 3103.

The other workers waiting for work wakeup from sleep, when signaled by the dispatcher, and retrieve the node function number 1203 from the worker structure, and when it matches with the predefined special value for the EXIT_FUNCTION, the Worker terminates itself, by exiting the Run_worker function 3204. The dispatcher terminates in exactly the same way, except that it is not signaled, but will check for the self-assignment flag, after removing the frame lock 1104.

4) Run_Dispatcher Function 3205:

The Run_Dispatcher function 3205, retrieves the frame status 1101 from the frame structure FIG. 11, of the frame table entry and identified by the frame number. If the frame status 1101, is either PGM_TERMINATED or FRAME_TERMINATED it returns return codes PGM_TERMINATED or FRAME_TERMINATED and terminates execution.

If the frame status 1101, is either RUNNING or STOP, it executes the internal function Select_Gates function 3206, of the Rcp runtime library, which binds node function invocations to queues, and sets the status of the node function invocation 3001, as WAITING_FOR_DISPATCH, and returns the cumulative count of node function invocations which are currently running, and the cumulative count of node function invocations which are selected for dispatch, for all Rcp Gates.

If the frame status 1101, is either RUNNING or STOP, and the cumulative count of node function invocations selected for dispatch is greater than zero, then the internal function Dispatch_Fctns 3212, of the Rcp runtime library is executed, which attempts to assign the idle workers of the frame, to the node function invocations, waiting for dispatch.

If the frame status 1101, is STOP and the cumulative count of node function invocations which are currently running are zero, then the Run_Dispatcher function 3205, returns the return code STOP and terminates execution.

If the frame status 1101, is RUNNING and the cumulative count of node function invocations which are currently running are zero, then the Run_Dispatcher function 3205, returns the return code IDLE and terminates execution.

5) Select_Gates Function 3206:

The Select_Gates function 3206, walks through the Node function table 0108, and selects the next Rcp Gate. It may be noted that the Rcp translator loads the Rcp Gates, ahead of node functions in the Node function table, and since the number of Rcp Gates are known, Select_Gates function need only traverse the entries from zero to Number of Rcp Gates less 1.

For each of the Rcp Gates, the Select_Gates function 3206, executes the internal function Bind_Virtual_Queues 3207 of Rcp runtime library, which binds the available queues to the Rcp Gate, and updates the input queues available 2807 and output queues available 2808 fields, in the Rcp gate node structure FIG. 28.

If the Node function invocations selected field 2805 of the Rcp Gate is greater than zero, then the Rcp Gate is bypassed, and the Next Rcp Gate is selected for processing, since this condition implies that previously selected node function invocations are not yet dispatched.

If the input queues available 2807, and the output queues available 2808 are greater than zero then the Rcp gate efficiency is computed by the equations given below,

A=Next_output_bind_seq_num2815*100;

B=Number_of_worker_assignments 2806*min(min(capacity of input queue arrays 2401), min(capacity of output queue arrays 2401));

Rcp Gate Efficiency=A/B;

It may be noted that if the number of worker assignments 2806 is zero, the Rcp Gate efficiency is set to 100%. Similarly if the Producers Terminated field 2819 has a value of 1, the Rcp Gate efficiency is set to 100%.

If the Node function invocations running field 2804 of the Rcp Gate node structure is zero, then the invocation of the node function whose status is READY, is selected for dispatch, provided that the Rcp gate efficiency is greater than 25% or both input_queues_available 2807 and output_queues_available 2808 are greater than 25% of the minimum capacity of the input and output queue arrays. If efficiency and available queues condition described above is not met, the Rcp gate is bypassed, and the next Rcp Gate is selected for processing.

If the Node function invocations running field 2804 of the Rcp Gate node structure is greater than zero, then the invocation of the node function whose status is READY is selected for dispatch, provided such an invocation exists, and provided that the Rcp gate efficiency is greater than 75%, and both input queues available 2807 and output queues available 2808 are greater than 75% of the minimum capacity of the input and output queue arrays. If efficiency and available queues condition described above is not met, the Rcp gate is bypassed, and the next Rcp Gate is selected for processing.

The Select_Gates function 3206, then binds the input and output queues of the selected node function invocation, by executing an internal Rcp runtime function called Rebind_Virtual_Queues 3208, often referred to as the Rebind function. The rebind function can fail if null binding is encountered, in which case the rebind operation is repeated.

If the Rebind_Virtual_Queues function 3208 fails to bind the queues, and if both input_queues_available 2807 and output_queues_available 2808 are zero, then the Rcp Gate is is bypassed, and the next Rcp Gate is selected for processing. Despite the initial check which ensures the availability of queues, the Rebind_Virtual_Queues function 3208, may fail, and the reason for this failure may be attributed to other node function invocations already running, which might have processed the queues.

If the Rebind_Virtual_Queues function 3208 succeeds in binding the queues, the status of the node function invocation 3001 is set to WAITING_FOR_DISPATCH, and the Node function invocations selected field 2805 in the Rcp Gate structure is incremented by 1, in a thread safe manner, by using the atomic increment instruction of the host language or the operating system.

As mentioned previously, the Select_Gates function 3206, maintains two counters, which contain the cumulative count of the node function invocations selected and the cumulative count of the node function invocations running, for all Rcp gates. These two counters are incremented by 1. It may be noted that the cumulative counter for node invocations running is updated ahead of time, in order to keep the frame from terminating.

6) Bind_Virtual_Queues Function 3207:

The Bind_Virtual_Queues function 3207 has five stages. Please refer to Appendices B thru E for more information on binding in Rcp architecture. In the first stage, the function initializes a temporary variable called Ready queue bits mask to all 1's. The ready queue bits mask variable is of the type STATUS BITS, described previously. For each input queue array of the Rcp Gate, the ready queue bits 2404 are obtained from the queue array node structure FIG. 24, and a logical conjunction (logical AND) is performed, with the ready queue bits mask, and the result is stored back in the ready queue bits mask. If the ready queue bits 2404 of the input queue array is zero and if the queue array has no producers, then the Terminate_Gate function 3211 of the Rcp runtime library is executed and the Bind_Virtual_Queues function 3207 returns back with the return code GATE_TERMINATED. If the queue array has no producers and if the ready queue bits 2404 of the input queue array is greater than zero, the Producers Terminated field 2819 of the Rcp Gate node structure FIG. 28, is set to 1.

For each input queue of the Rcp Gate, the Ready queue bits mask remains unchanged, if the status of the queue is READY else the Ready queue bits mask is set to zero. At the end of the operation the ready queue bits mask field contains the ready queue bits of the input queue arrays, which is stored in a temporary field called Ready queue bits. It may be noted that if all the queues at a particular queue index are ready then the corresponding bit will be set to 1, else it will be 0.

A similar operation is performed for null queue bits except that a logical disjunction (logical OR) is performed with the null queue bits 2406 stored in the queue arrays, and the null queue bits mask temporary field is initially set to zero. The result is stored in a temporary variable called Null queue bits.

In the second stage, the ready queue bits stored in the temporary field are traversed, starting from bit numbered zero. It may be noted that each bit is referred to as the input queue index. When a bit is set to 1, the corresponding entry in the bind seq num table of the queue array structure is located using the input queue index, and the bind seq number 2502 is retrieved from the bind seq num structure FIG. 25. This bind seq num is referred to as the current bind seq number. If the current bind seq num is less than the Next input bind seq num 2814 of the rcp gate it is ignored, otherwise, the difference between the current bind seq num and the Next input bind seq num 2814 of the Rcp gate is computed and added to the Bind table input index field 2811 of the Rcp Gate structure, and an index to the Bind_Table 2810 of the Rcp Gate is obtained. If the index is greater than the max size of the bind table 2810, it is decremented by the max size of the bind table 2810. It may be noted that if the Rcp gate is dependent upon queues only, then the bind seq num table 2408 does not exist, in this case the Bind_Virtual_Queues function 3207, supplies the current bind seq num which is equal to the Next input bind seq num 2814, of the Rcp gate, plus the iteration number.

After computing the index to the Bind table 2810, where the current bind seq number would be stored, the bind flag 2901 of the bind node structure FIG. 29, located at the entry identified by the index computed above, is tested for either a value of 0 (free) or 3 (outputs bound). If the bind flag 2901 has any other value it means that previous binding is still in effect and the current bind seq num will have to wait. If the bind flag 2901, is 0 or 3 then the bind flag 2901 is incremented by 1, and the input queue index (ready queue bit number), is stored in the Input queue index field 2903 of the bind node structure. The current bind seq num is also stored in the bind node structure, in the Input bind seq num field 2905, of the bind node structure. If in addition to the ready queue bit, the null queue bit is also set, the null flag 2902 of the Bind node structure is set to 1. The number of ready queue bits processed is added to Pending inputs field 2809, of the Rcp Gate node structure. It may be noted that there can be gaps in the bind seq numbers which arrive to the Rcp gate. It may be noted that the Bind table input index 2811, and Next input bind seq num 2814, still have the original values.

The Bind table referred by 2810, is now traversed starting from the Bind table input index 2811, until a temporary counter loaded with pending inputs 2809 expires. The Bind flag 2901 of each entry in the Bind table referred by 2810 is examined for values 1 or 4. If these values are found, then it implies that inputs are pending, and the bind flag 2901 is incremented by 1, and the new values can now be 2, or 5, which means that inputs are available. If any of the entry does not have the required values of 1 or 4, then it indicates that there are gaps in inputs, and the processing stops at the first gap encountered. The number of entries processed are stored in a temporary variable called available queues.

At the end of the second stage, the pending inputs field 2809 of the rep gate is decremented by the number of available queues. The Next input bind seq num 2814 of the Rcp Gate node structure is incremented by the number of available queues. The Bind table input index 2811 in the Rcp Gate node structure is incremented by the number of available queues, and a wrap around logic is performed to ensure that the result is still a valid index for the Bind_table. This completes the second stage of Binding.

In the third stage, the function initializes a temporary variable called Not Ready queue bits mask to all 1's. The not ready queue bits mask variable is of the type STATUS BITS, described previously. For each output queue array of the Rcp Gate, the not ready queue bits 2405 are obtained from the queue array node structure and a logical conjunction (logical AND) is performed, with the not ready queue bits mask, and the result is stored back in the not ready queue bits mask. At the end of the operation, the not ready queue bits mask field contains the not ready queue bits of all the output queue arrays, which is stored in a temporary field called Not Ready queue bits. It may be noted that if all the queues at a particular queue index are not ready then the corresponding bit will be set to 1, else it will be 0.

In the fourth stage, the local ring number 1707 associated with the Rcp Gate is retrieved from the node function table entry, at index location identified by the Rcp gate number. The local ring of the local ring table entry, at index location identified by the local ring number 1707, is locked by acquiring the Lock for Bind info bits 1902 of the local ring structure FIG. 19. The bind info bits 1901, are retrieved from the local ring structure FIG. 19. Each bit identifies whether the output queue index is already bound (value 1) or not bound (value 0). It may be noted that these bits are required to identify previous bindings. A complement of the bind info bits 1901 is obtained and a logical conjunction (logical AND) is performed with the Not ready queue bits obtained above, and the result contains a 1, whenever the output queues at that output queue index are Not ready and not previously bound.

The Bind flag 2901 of the Bind table entry indexed by the Bind table output index 2812 is examined for values 1 or 2 (these values indicate that inputs are bound). If the null flag 2902 of the Bind table entry is set to 1, the entry is skipped, and processing resumes with the next entry. If the null flag 2902 is set to zero, the not ready queue bits, which are not previously bound (obtained above), are traversed starting from the bit zero, and the index of the bit which has a value of 1, is obtained, and stored in the output queue index 2904 of the Bind node structure FIG. 29. The output bind seq num 2906 of the Bind node structure FIG. 29, is set to the Next Output bind seq num 1903 of the local ring, and the value of the Next Output bind seq num 1903, in the local ring is incremented by 1. Please refer to Appendix—A for the theory behind these operations. The bind flag 2901, of the bind table entry is incremented by 3. The bind info bit located at bit number identified by the output queue index 2904, in the bind info bits 1901 of the local ring structure is set to 1. The output queues available temporary variable is incremented. The next bind table entry is selected for processing, until an entry is found with bind flag 2901 values other than 1 or 2. It may be noted that the Bind table output index 2812 still has the original value.

When the Bind flag 2901 field with values other than 1 or 2 is found, in the Bind table entry, the Lock for Bind info bits 1902 of the local ring is released. The Next output Bind seq num 2815 of the Rcp gate is incremented by the number of output queues available. The Bind table output index 2812 of the Rcp Gate node structure is incremented by the number of output queues available, and a wrap around is performed if necessary, to keep the index valid. This completes the processing for the fourth stage.

In the fifth stage of the processing, the Bind lock 2816 of the Rcp gate node structure is acquired, and the input queues available 2807, and output queues available 2808 fields of the Rcp gate are incremented with the input queues available and output queues available counters (temporary variables), maintained during the second and the fourth stage processing. The Bind lock 2816 of the Rcp gate node structure is released. If either the input queues available 2807 and output queues available 2808 fields of the Rcp gate are zero the Bind_Virtual_Queues function 3207, returns a Bind Failed return code, else it returns 1, signaling that the Bind_-Virtual_Queues function was successful.

7) Rebind Virtual Queues Function 3208:

The rebind virtual queues function 3208, binds the virtual queues of the node function to real queues. It may be noted that the Rcp gate locates the complete set of input queues, and output queues (identified by input queue index, and output queue index), required to run the node function invocation. Each complete set is stored in the bind table entry. The Rebind_Virtual_Queues function simply retrieves input queue index 2903, and output queue index 2904, from the bind table entry located at the index identified by the Rebind index field 2813, and binds the input queue index 2903, and output queue index 2904, to the node function invocation, as explained below. The term rebind is chosen to describe this activity because, the Rcp Gate already identified the queues and bound them to itself, and the node function simply retrieves the input and output queue indices.

The references to the gate node structure FIG. 28, and the Bind table structure FIG. 29, are established during initialization, using the Rcp gate number and the node function status table 0110.

The Rebind_Virtual_Queues function 3208, begins by acquiring the rebind lock 2817 of the Rcp gate. The rebind index 2813, of the Rcp gate is retrieved. The Bind flag 2901, and the Null flag 2902, of the Bind table entry indexed by the Rebind index 2813, are examined for value of 5 and 1 respectively. If either of the conditions is met, the function continues with further processing, else the function releases the rebind lock 2817, changes the status of the Rcp Gate 2801 to REBIND_FAILED, and returns a Rebind failed return code.

The input queue index 2903, output queue index 2904, and the output bind seq number 2906, of the Bind table entry identified by the rebind index 2813, are copied to the input queue index 3004, output queue index 3005, and the bind sequence number 3006, of the node function invocation structure FIG. 30, identified by the node function number and the node function invocation number. The value of the rebind index 2813, is stored in the rebind index field 3003, of the node function invocation structure FIG. 30. The Bind status field 3002, of the node function invocation is set to BOUND.

If the null flag 2902 of the bind table entry is set to zero (non null binding), then the bind flag 2901 is incremented by 1. If the null flag is set to 1 (null binding), the internal function Unbind_Null_Binding 3215 of the Rcp runtime library, is executed, to discard the null binding.

The rebind index 2813, is incremented and a wrap around is performed if necessary, to keep the index valid. The rebind lock 2817 is released.

If null flag is set to 1, at the beginning of this function, then the function terminates with a special return code called “NULL BINDING SKIPPED”, else processing terminates successfully by returning the output bind seq number 2906.

8) Unbind_Virtual_Queues Function 3209:

The Unbind_Virtual_Queues function 3209 of the Rcp runtime library disassociates the queues bound to the node function invocation.

During initialization, this function obtains the reference to the Gate node 2704, from the node function status table 0110, using the Rcp gate nun as index. It obtains the reference to the node function invocation table 2703 from the node function status table 0110, using the node function num as index. It obtains the reference to the node function invocation structure FIG. 30, using the node function invocation table 2703 and the node function invocation number.

It may be noted that as explained previously the Rcp Gate uses the node function info table 0109 to store the queue arrays defined on its input and output side. The node function info offset 1702 is obtained from the node function table entry indexed by the Rcp gate num. The node function info structure FIG. 18, is obtained from the node function info table 0109, using the node function info offset 1702. The prefix of the node function info structure contains the number of input queues or input queue arrays for the Rcp Gate. The location of the queue or queue array info is obtained by adding the length of the node function info prefix for Rcp gates to the node function info offset 1702, retrieved above. The location and number of input queues or input queue arrays allow this function to retrieve the input queue arrays.

Each input queue num or input queue array num stored in the node function info table 0109 for the Rcp Gate is retrieved, of which only the queue arrays are selected and the non queue arrays are bypassed. The input queue index 3004 retrieved from the node function invocation structure FIG. 30, will point to the queue in each of the input queue arrays, which is bound to the node function invocation. For each input queue array number retrieved, an internal Rcp implentation function called Reset_Queue 3210 is executed, which resets the input queues bound to the node function invocation. This completes unbinding the input queues of the node function invocation.

The local ring number 1707 connected to the Rcp gate is obtained from the node function table entry indexed by the Rcp gate number. The output queue index 3005, is retrieved from the node function invocation structure. As explained previously the output queue index 3005, points to the output queue, in each of the output queue arrays which is bound to the node function invocation. The lock for bind info bits 1902 contained in the local ring table entry indexed by the local ring number, is acquired. The bind info bit located at the index corresponding to the output queue index 3005 is reset (set to zero), and the lock for bind info bits 1902 is released. This completes unbinding the output queues of the node function invocation.

The Bind status flag 3002 of the node function invocation structure FIG. 30, is set to UNBOUND. The rebind index 3003 is retrieved from the node function invocation structure, FIG. 30. The bind flag 2901 and the null flag 2902 contained in the bind table entry pointed by the rebind index 3003 are reset to zero. The bind lock 2816, contained in the Rcp gate node FIG. 28, is acquired and the input queues available 2807 and the output queues available 2808 are decremented, and the bind lock 2816 is released.

This completes the Unbind_Virtual_Queues function 3209, and the function returns with a successful return code.

9) Unbind Null Binding Function 3215:

The Unbind_Null Binding function 3215, is a special version of the Unbind_Virtual_Queues function 3209 described above. This function unbinds only the input queues or input queue arrays. It may be noted that when a null queue appears on the input side of the Rcp Gate, all the input queues located at that input queue index are considered as a null. As explained previously the Rcp gate will not complete the null binding, that is it will not allocate output queues, and will not call the node function invocation, instead it unbinds the null binding. The reason for processing the null bindings is that the Rcp Gate expects every bind seq number generated by the top level Rcp gate to appear on its input side, else it would stall. The stalling of Rcp Gate is explained in the second stage of the Bind_Virtual_Queues function 3207, where the Rcp Gate does not increment the Bind table input index 2811, when it sees a gap in bind seq numbers.

The Unbind_Null_Binding function 3215, unbinds the input queues exactly as the Unbind_Virtual_Queues function 3209, describe above. The output queues are not allocated to a null binding and hence there is no need to unbind outputs. The rebind index 3003 is retrieved from the node function invocation structure FIG. 30, and the bind flag 2901 and the null flag 2902 contained in the bind table entry pointed by the rebind index 3003 are reset to zero. The bind lock 2816 contained in the Rcp gate node FIG. 28, is acquired and the input queues available field 2807 is decremented, and the bind lock 2816 is released. This completes the Unbind_Null_Binding function 3215, and the function returns with a successful return code.

10) Reset_Queue Function 3210:

The Reset_Queues function 3210, receives the queue array number and the queue number within the queue array as formal parameters. It retrieves the references to the queue table 1107, queue status table 1108 and the queue info table 1109 from the frame table entry indexed by the frame number. These references are referred to as the original references.

The Reset_Queues function 3210, then retrieves the reference to the queue array node 2003 contained in the original queue status table entry indexed by the queue array number. From the queue array node structure 2003 the references to the queue table 2402 and queue status table 2403 of the queue array are retrieved. Using the reference to the queue status table 2403 (retrieved from the queue array), and the queue number received as a formal parameter the reference to the queue data node 2002, is retrieved from the queue status structure FIG. 20. From the reference to the queue data node 2002, the reference to the queue header structure FIG. 22, is obtained by host language mechanism called type casting.

The queue lock 2005 in the queue status table entry indexed by the queue number is acquired and the consumer lock count 2201 in the queue header is decremented, and the queue lock 2005 is released. If the consumer lock count 2201 is still greater than zero the function terminates with a successful return code. It may be noted that consumer lock count 2201 greater than zero implies that other consumers are still using the queue.

When the consumer lock count 2201 drops down to zero, the status of the queue 2001, contained in the queue status table entry indexed by the queue number is set to NOT READY. The last element field 2205 contained in the queue header is reset to zero. The consumer lock count 2201 is reset to its original value, which is the number of consumer functions 1602, retrieved from the prefix of the queue info node structure FIG. 16. The queue info node structure is obtained by using the queue info offset 1502, which is retrieved from the queue table entry indexed by the queue number.

The Bind seq num table reference 2408 is obtained from the queue array node. The bind seq number 2502 located at the bind seq number table entry indexed by the queue number is reset to zero. The lock for queue bits 2407, contained in the queue array node structure FIG. 24, is acquired and the ready queue bit in the ready queue bits field 2404, and the null queue bit in the null queue bits field 2406, corresponding to the queue number is set to zero. The not ready queue bit in the not ready queue bits filed 2405 corresponding to the queue number is set to one. The lock for queue bits 2407 contained in the queue array node structure is released. The function returns with a successful return code.

11) Release_Queues Function 3112:

The Release_queues function 3112, in the Rcp runtime library corresponds to the Release Queues Rcp statement. Since this function is called by the node function it has only two formal parameters which are the statement number and the Run_id FIG. 14. During initialization this function retrieves the frame number 1401 from the run id and obtains the reference to the frame node structure FIG. 11. The worker id 1402 in the Run_id FIG. 14, is used to obtain the worker node structure FIG. 12, of the worker table entry. From the worker structure FIG. 12, the node function number 1203 and node function invocation number 1204 are obtained. The Rcp Gate num 1705 is obtained from the node function structure FIG. 17, located at the node function table entry indexed by the node function number.

This functions executes the Unbind_Virtual_Queues function 3209, and unbinds the queues bound to the node function invocation. The release lock 2818 of the Rcp gate node is acquired, and the Gate function release bit in the Gate function release bits 2702, corresponding to the node function invocation is set to zero. If the Gate function release bits field 2702 becomes zero the internal function provided by the Rcp runtime called Terminate_Gate 3211, is executed. The status of the node function invocation 3001 is set to TERMINATED. The Release lock 2818 of the Rcp gate node is released, and the function returns with a successful return code.

12) Terminate_Gate Function 3211

The Terminate_Gate 3211 function walks thru each of the input queues and queue arrays of the Rcp gate, and deletes them, by releasing the physical memory allocated to the structures. The status of the Rcp Gate in the Rcp Gate node is set to TERMINATE. The producer lock count field 2202 of the output queue arrays is decremented by 1. The function returns with a successful return code.

13) Rebind_Queues Function 3111:

The Rebind_Queues function 3111 in the Rcp runtime library corresponds to the Rebind_Queues Rcp statement. Since this function is called by the node function it has only two formal parameters which are the statement number and the Run_id FIG. 14. The Rcp Gate num 1705 is obtained from the node function structure FIG. 17, during initialization, as explained before in the Release Queues function 3112.

This function executes the internal Rcp function Unbind_Virtual_Queues 3209, followed by the Rebind_Virtual_Queues function 3208. It may be noted that both Unbind_Virtual_Queues 3209 function, and Rebind_Virtual_Queues function 3208 take Statement number, frame number, Rcp gate number, node function number and invocation number as formal parameters. The function then returns a successful return code.

14) Terminate Run Function 3113:

The Terminate_Run function 3113 in the Rcp runtime library corresponds to the Terminate Run_Pgm statement. This function receives the statement number and Run_id as formal parameters.

This function retrieves the frame number 1401 and worker id 1402 from the Run_id FIG. 14. The reference to the worker table 1114 is retrieved from the frame structure FIG. 11, in the frame table entry corresponding to the frame number. The Worker flag 1205 of the worker structure FIG. 12, in the worker table entry, corresponding to the worker id is set to a value of TERMINATE. The function returns a return code TERMINATE.

15) Stop_Run Function 3114:

The Stop_Run function 3114 in the Rep runtime library corresponds to the Stop Run Rcp statement. This function receives the statement number and Run_id as formal parameters.

This function retrieves the frame number 1401 and worker id 1402 from the Run_id FIG. 14. The reference to the worker table 1114 is retrieved from the frame structure FIG. 11, in the frame table entry corresponding to the frame number. The Worker flag 1205 of the worker structure FIG. 12, in the worker table entry, corresponding to the worker id is set to a value of STOP. The function returns a return code STOP.

16) Dispatch_Fctns Function 3212:

The Dispatch_Fctns function 3212, of the Rcp runtime, walks through the node function table 0108, and selects each node function. The reference to the node function invocation table 2703 is obtained from the node function status table 0110. For each node function invocation in the invocation table, the invocation status 3001 is examined for a value of WAITING_FOR_DISPATCH. If the invocation is waiting for dispatch, as determined by the invocation status 3001, then a Worker is assigned to the node function invocation. The code of this function is executed by the dispatcher of the frame, which checks the self assignment flag 1106 to see if it already assigned work to itself If the self assignment flag 1106, is zero the dispatcher copies the node function number and invocation number to the node function number 1203, and invocation number 1204, of the worker structure in the worker table indexed by the worker number of the dispatcher. If the self assignment flag 1106 is set to 1, the dispatcher walks through the worker table, and examines the worker status field 1202 for READY status. The first worker found in READY status is selected, and the dispatcher copies the node function number and invocation number to the node function number 1203, and invocation number 1204, of the worker structure in the worker table indexed by the worker number. Whenever an assignment to a worker is made, including the self assignment, the worker status 1202 is set to RUNNING. The status of the node function invocation 3001 is set to RUNNING. If the assignment is not a self assignment, the worker to which the assignment is made is signaled. The Rcp Gate number 1705 of the node function is retrieved, and the Number of worker assignments field 2806 of the Gate Node structure is incremented. The node function invocations selected field 2805 of the Rcp gate node structure FIG. 28, is decremented using atomic decrement instruction of the host language or operating system. The node function invocations running field 2804 of the Rcp Gate node structure FIG. 28, is incremented using atomic increment instruction of the host language or operating system.

17) Node_Function_Termination Function 3213:

The Node_Function_Termination function 3213 of the Rcp runtime library, is called by the Rcp runtime to reset the node function invocation. This function receives the frame number, worker id, node function number and invocation id as formal parameters.

The references to node function table, node function status table, and worker table are retrieved from the frame structure FIG. 11, during initialization.

The frame status lock 1105 is acquired. If the Worker flag 1205 is either set to STOP or TERMINATE by the Stop_Run 3114, or Terminate_Run 3113 statements, then the frame status 1101 is set to STOP or TERMINATE. The frame status lock 1105 is released. The Rcp gate num 1705 is retrieved from the node function table entry indexed by the node function number. The Rcp Gate Node 2704 is obtained from the node function status table entry indexed by the Rcp Gate number.

The Unbind_Virtual_Queues function 3209, is executed, to unbind the virtual queues. It may be noted that the node function is supposed to return control back only when Rebind_Queues function 3111, fails to rebind, in which case the queues are already unbound. If the developer has not followed the recommendations, and if the node function returns after processing some of the queues, then the Rcp runtime executes the Unbind_Virtual_Queues function 3209, on behalf of the node function.

The Node function invocations running field 2804, of the Rcp Gate node structure FIG. 28, is decremented using the atomic decrement instruction of the host language or the operating system.

The reference to the node function invocation table 2703, is retrieved from the node function status structure FIG. 27, of the node function status table entry indexed by the node function number. The status of invocation 3001, of the node function invocation table entry indexed by the node function invocation number, is set to READY, provided it is not already set to TERMINATED.

The Node function number 1203, the node function invocation number 1204, and the worker flag 1205, of the worker table entry indexed by the worker number are set to NULL.

The Node_Function_Termination Function 3213, returns with a successful return code.

18) Create_Queue_Array Function 3104:

The Create_Queue_Array function 3104 in the Rcp runtime library corresponds to the Create_Queue_Array Rcp statement. The function examines the type of the queue array 1501, in the queue structure, and determines the type of queue that will be stored in the queue array. The queue info offset 1502 for the queue array is obtained from the queue table entry indexed by the queue array number. Using the queue info offset 1502 the queue info record FIG. 16, for the queue array is obtained. From the prefix of the queue info record, the number of consumers 1602 and producers 1603 for the queue array are obtained.

The queue lock 2005 contained in the queue status table entry indexed by the queue array num is acquired.

A new copy of the queue array node FIG. 24, is created in memory, and the number of queues formal parameter value is stored in the number of queues field 2401, of the queue array node. A new copy of the Queue table with size equal to the number of queues, is created and the reference to this table is stored in the reference to queue table 2402 of the queue array node. Similarly a queue status table of size equal to the number of queues, is created and the reference is stored in the reference to queue status table 2403 of the queue array node. The lock for queue bits 2407 of the queue array node is initialized to zero. The Ready queue bits field 2404 of the queue array node is set to zero. The not ready queue bits field 2405 of the queue array node is set to a value equal to 2 to the power of Number of queues minus 1. The null queue bits field 2406 of the queue array node is set to zero.

Each entry of the queue table 2402 and queue status table 2403 contained in the queue array node, is initialized as explained below.

The type of the queue field 1501 of the queue table entry is set to the type of the queue determined above. The Queue info offset 1502 of the queue table entry is set to queue info offset 1502 of the queue array. It may be noted that the queues contained in the queue array will use only the prefix portion of the queue info, and hence this is a safe operation. The Bind to queue num 1503, of the queue table entry is set to null. The disposition queue number 1504, and the Input_output flag 1505 are set to NULL.

The status 2001 of the queue status table entry is set to NOT_READY. The queue lock 2005 of the queue status table entry is set to zero. The reference to the queue data node 2002 of the queue status table entry is set to null. The reference to the queue array node 2003/virtual queue node 2004 of the queue status table entry is set to null.

This completes the initialization of the queues contained in the queue array. It may be noted that the queues are not being created, but the structure of the queues is being built. In other words, what is built here for each queue (in the queue array), is what the Rcp translator would have built for a normal queue definition.

A new copy of the queue header node FIG. 22, is created in memory for the queue array and is initialized as explained below. The producer lock count 2202 and consumer lock count 2201 are set to number of producers and number of consumers determined from the prefix of the queue info structure of the queue array. The element size field 2203 and the last element field 2205 are set to zero. The number of elements 2204 is set to the number of queues. The reference to the lock table 2206 is set to null. This completes the creation and initialization of the queue header used by the queue array.

The queue status table entry of the frame indexed by the queue array number is initialized as follows. The status 2001, of the queue status table entry is set to READY. The reference to the queue header node created above is stored in the reference to the queue data node field 2002. The reference to the queue array node created above is stored in the reference to the queue array node 2003. The queue lock 2005 contained in the queue status table entry indexed by the queue array num is released.

The create queue function 3105, is called for each queue in the queue array, and the queue element size, and the number of elements are passed to the create queue function. The queues created are initially set to not ready state, by sending the formal parameter request status as zero, to the create queue function. Since the queue is being created directly instead of through the virtual queues, the queue array number and queue number are also passed as formal parameters to the create queue function. After all the queues contained in the queue array are created, the function returns a successful return code to the caller.

19) Create_Queue Function 3105:

The Create_Queue function 3105 in the Rcp runtime library corresponds to the Create Queue Rcp statement. This function receives Run_id FIG. 14, Queue array num, queue number, element size, number of elements and the request status (state in which the queue should be placed after creation), as formal parameters. This function is very flexible and can create a queue, or a queue contained in a queue array, specified by the combination of queue array and queue number, or a queue referred by the virtual queue, where the queue array number and queue number are implicitly specified.

This function retrieves the references to the queue table 0105, the queue info table 0106, and queue status table 0107 of the frame during initialization. It executes the internal function Security Check 3214 of the Rcp runtime library, which translates the queue number, if it is of type virtual, to the queue array number and queue number combination. If the queue array number is specified directly in the formal parameter or indirectly as a virtual queue, the reference to queue array node 2003, is retrieved from the queue status table entry indexed by the queue array number. The reference to the queue table 2402 and queue status table 2403 in the queue array node FIG. 24, are retrieved.

The above operation, where the queue table 0105 and queue status table 0107 of the frame are replaced by the queue table 2402 and queue status table 2403 of the queue array, is called virtual magic. The function has no clue whether it is acting up on the queue, contained in the queue tables of the frame, or whether it is acting upon the queue contained in the queue array, which is contained in the queue tables of the frame.

The queue lock 2005 contained in the queue status table entry indexed by the queue number is acquired. A buffer of size equal to the Queue header length plus the length of the reference or pointer field (in the host language) multiplied by the number of elements of the queue, is allocated. In other words, the buffer will contain the queue header FIG. 22, followed by a reference field for each element of the queue, which points to the element's data, as depicted in FIG. 21. Each of the references to the elements data are initialized to nulls.

The type of the queue 1501 is retrieved from the queue table entry, indexed by the queue number. The type of the queue is examined for type Input-Output, if the condition is met, a new copy of the lock table is allocated using the lock structure FIG. 23, and the number of elements in the queue. For each entry in the lock table, the node function number field 2301 is initialized to −1, and the lock field 2302 is initialized to zero.

The queue header FIG. 22, contained in the buffer is initialized as follows. The element size parameter is stored in the element size field 2203 of the queue header. The num of elements parameter is stored in the num of elements field 2204 of the queue header. The last element field 2205 of the queue header is set to zero. The reference to lock table field 2206 of the queue header is set to the reference of the lock table created above. The consumer lock count 2201 of the queue header is set to the number of consumers field 1602 contained in the prefix of the queue info structure. The queue info structure FIG. 16, is located by the queue info offset 1502, retrieved from the queue table entry, indexed by the queue number. The queue lock 2005 contained in the queue status table entry indexed by the queue number is released.

The requested queue status formal parameter is examined for value READY. If the condition is not met, the program terminates with a successful return code. If the condition is met, and if the reference to the queue array node structure 2003 is null, the queue status field 2001, contained in the queue status table entry indexed by the queue number is set to READY. If the condition is met, and if the reference to the queue array node structure 2003 is not null, the lock for queue bits 2407, contained in the queue array node FIG. 24, is acquired. The ready queue bit in the ready queue bits field 2404, corresponding to the queue number, contained in the queue array node is set to 1. The not ready queue bit in the not ready queue bits field 2405, corresponding to the queue number, contained in the queue array node is set to 0. It may be noted that the null queue bit contained in the null queue bits field 2406, corresponding to the queue number, contained in the queue array node remains unchanged, at value 0. The queue status 2001 contained in the queue status table entry indexed by the queue number is set to READY, and the lock for queue bits 2407, contained in the queue array node is released. The function returns with a successful return code.

20) Add Queue Function 3106:

The Add Queue function 3106, in the Rcp runtime library corresponds to the Add Queue Rcp statement. This function receives the element size and a reference to the data to be stored in the queue, and the request status, in addition to the queue number and the Run_id formal parameters.

The function retrieves the references to the queue table 0105 and the queue info table 0106, and the queue status table 0107, of the frame during initialization. It executes the Security Check 3214 function of the Rcp runtime library, which translates the queue number, if it is of type virtual, to the queue array number and queue number combination. If the queue array num is greater than or equal to zero at the end of this operation, the references to the queue table 1107, and the queue status table 1108, of the frame held in temporary function variables are replaced by the references to the queue table 2402, and the queue status table 2403, contained in the queue array node structure FIG. 24.

The function retrieves the queue status 2001 and queue type 1501, as explained before, and examines the queue type for value TYPE_INPUT and the queue status for value READY. If the condition is met the function terminates further processing and returns an error code, since queues of type INPUT, cannot be modified after they are set to the READY state. However queues of type INPUT-OUTPUT can be modified even after they are set to READY state, and queues of both types can be modified as long as they are in NOT-READY state. If the queue is of type INPUT-OUTPUT and the queue status is READY, the queue lock 2005 contained in the queue status table entry indexed by the queue number is acquired.

The element number at which the data will be stored, is obtained by adding to the last element 2205 contained in the queue header FIG. 22, provided it is less than the number of elements 2204 of the queue header. If the last element number 2205 is equal to the number of elements 2204 of the queue header, then the element references contained in the queue data node FIG. 21, are searched until an element which is deleted previously, identified by the delete flag 2102, with value set to 1, in the queue data node is found. If an element cannot be found to store the data, the function returns with an error code. It may be noted that the storage allocated for the element, is never physically deleted until the queue itself is deleted.

The element size obtained as a formal parameter by this function represents the actual element size, of a particular instance and is validated to ensure it is less than the maximum specified by the Create queue function. It may be noted that each element is of fixed size, and the element size specified in the Create queue statement represents the maximum size which the element can hold.

If the element reference 2103, is not null it is reused for storing the data, else a new copy of the element of size equal to the element size 2203 of the queue header plus size of a prefix field 2104 to store the length of the data stored in the element, is allocated and the reference is stored in the reference to element data 2103, of the queue data node at the entry indexed by the element number. The element size specified in the formal parameter is copied to the prefix field 2104 of the buffer allocated for the element. The reference to the data specified as the formal parameter is used to copy the data to the element data buffer 2105 allocated for the element after the prefix. If the queue is of type INPUT-OUTPUT and the queue status 2001 is READY, the queue lock 2005 contained in the queue status table entry indexed by the queue number is released.

The requested queue status formal parameter is examined for value READY, and if the condition is met the queues is set to READY status as explained below.

If the reference to the queue array node structure 2003 is null, the queue status field 2001, contained in the queue status table entry indexed by the queue number is set to READY and the function terminates with a successful return code.

If the reference to the queue array node structure 2003 is not null the lock for queue bits 2407, contained in the queue array node FIG. 24, is acquired.

The reference to the node function invocation table 2703 is obtained from the node function status table 0110, using the node function number. The Bind seq num 3006 is obtained from the node function invocation table entry indexed by the invocation number. The reference to the bind seq num table 2408, is retrieved from the queue array node FIG. 24. The Bind seq num 3006 is copied to the Bind seq num 2502 of the Bind seq num table entry indexed by the queue number.

The ready queue bit in the ready queue bits field 2404, corresponding to the queue number, contained in the queue array node is set to 1. The not ready queue bit in the not ready queue bits field 2405, corresponding to the queue number, contained in the queue array node is set to 0. The null queue bit contained in the null queue bits field 2406, corresponding to the queue number, remains unchanged at value 0. The queue status 2001 contained in the queue status table entry indexed by the queue number is set to READY.

The lock for queue bits 2407, contained in the queue array node is released, and the function returns with a successful return code.

21) Read_Queue Function 3107:

The Read Queue function 3107, of the Rcp runtime library corresponds to the Read Queue statement. This function receives the element number and a reference to the destination, where the data retrieved from the queue should be stored, in addition to the queue number and the Run id FIG. 14, parameters.

The function retrieves the references to the queue table 1107 and queue status table 1108 of the frame during initialization. It executes the Security Check 3214 function provided by the Rcp runtime library, which translates the queue number, if it is of type virtual, to the queue array number and queue number combination. If the queue array num is greater than or equal to zero at the end of this operation, the references to the queue table 1107, and the queue status table 1108, of the frame held in temporary function variables are replaced by the references to the queue table 2402, and the queue status table 2403, contained in the queue array node structure FIG. 24.

The queue type 1501 and queue status 2001 are retrieved from the queue table 0105 and the queue status table 0107 as explained before. The queue type 1501 and queue status 2001 are examined for type INPUT-OUTPUT and status READY, if the condition is met, then there is a possibility of concurrent updates from other workers, hence a read lock is obtained by atomically incrementing the lock field 2302 of the lock table entry indexed by the element number minus 1, provided the lock field 2302 contents are greater than or equal to zero before the increment.

The reference to the queue data node 2002 contained in the queue status table entry indexed by the queue number is retrieved. The reference to the element data 2103 is obtained from the element table entry indexed by the element number. Using the reference to the element data, the size of the element data is obtained from the prefix field 2104 of the element data. The element data 2105 is then copied to the reference of the destination data field, received as a formal parameter. If the read lock is acquired before, it is released by atomically decrementing the lock field 2302, of the lock table entry indexed by the element number minus 1. The function terminates successfully and returns the size of the element obtained from the element prefix 2104.

22) Null_Queue Function 3110:

This function receives the queue number in addition to the Run_id and Statement number. The reference to the queue table 1107, the reference to the queue status table 1108, and the reference to the node function status table 1111 of the frame, are obtained during initialization. The type 1501 of the queue is validated to ensure it is of type VIRTUAL. In other words, only virtual queues are processed by this function.

This function executes the Rcp internal function Security_Check 3214, which translates the virtual queue number received as the formal parameter to a combination of the queue array number and the queue number. The reference to the queue array node FIG. 24, is obtained from the queue status table 0107, using the queue array number as index. The references to the queue table 1107 and queue status table 1108 of the frame, stored in the temporary variables of the function, are replaced by the reference to the queue table 2402 and the reference to the queue status table 2403 contained in the queue array node structure FIG. 24, obtained above.

The lock for queue bits 2407, contained in the queue array node FIG. 24, is acquired. The reference to the node function invocation table 2703 is obtained from the node function status table 0110, using the node function number. The Bind seq num 3006 is obtained from the node function invocation table entry indexed by the invocation number. The reference to the bind seq num table 2408, is retrieved from the queue array node FIG. 24. The Bind seq num 3006 is copied to the Bind seq num 2502 of the Bind seq num table entry indexed by the queue number.

The ready queue bit in the ready queue bits field 2404, corresponding to the queue number, contained in the queue array node is set to 1. The not ready queue bit in the not ready queue bits field 2405, corresponding to the queue number, contained in the queue array node is set to 0. The null queue bit contained in the null queue bits field 2406, corresponding to the queue number, contained in the queue array node is set to 1. The queue status 2001 contained in the queue status table entry indexed by the queue number is set to READY.

The lock for queue bits 2407, contained in the queue array node is released, and the function returns with a successful return code.

23) Security_Check Function 3214:

This function examines the queue status 2001 contained in the queue status table entry indexed by the queue number for the value VIRTUAL. If the condition is met, the Bind to queue number 1503 is retrieved, from the queue structure FIG. 15.

The node function number 1203 and the node function invocation number 1204 are retrieved from the worker table entry indexed by the worker id.

If the Bind to queue number 1503 is not a queue array then this function returns a null for the queue array and the Bind to queue number 1503 as the queue number. If the Bind to queue number 1503 is a queue array, then the queue number is obtained by selecting either the input queue index 3004 or output queue index 3005 of the node function invocation table entry, indexed by the node function invocation number, depending upon whether the Io_Flag 1505, of the queue table entry indexed by the virtual queue number is either 1 (input) or 2 (output). The function returns the queue number obtained above, and the Bind to queue number 1503, as the queue array number.

c) Operation of the Sample Application:

The processing of the sample application comprises of the steps of:

1) Reading the claims from the claim file.

2) Processing the claim, which in turn comprises of the steps of:

1) Reading the Policy record from the policy file, using the policy number in the claim record.

2) Reading the Policy rules record from the policy rules file, using the policy rule id, of the policy record, and the claim type of the claim record, and obtaining the maximum amount that can be paid for the claim type, in a year.

3) Reading the policy limits file, and obtaining the amount paid for the policy for the entire year.

4) Computing the total of the amount paid in the year and the claim amount and comparing the total with the maximum allowable under the policy, and determining whether total, partial or no payment is to be done for the claim.

3) Rejecting the claim, if payments made in the year exceeds the maximum allowable under the policy, and writing the claim record to a reject file, and writing the history record to the history file.

4) Making payment to the claim by writing the claim to the payment file, and writing the history record to the history file.

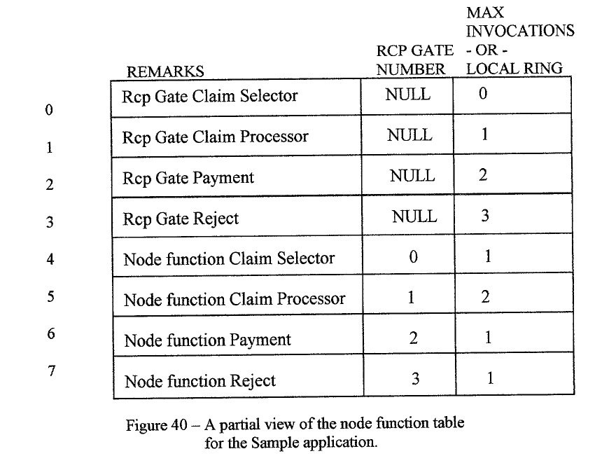

The operation of the sample application is explained with the help of flow charts depicted in FIGS. 35 thru 39, and with the help of application trace depicted in FIGS. 40 thru 48. The application trace is generated by the application when it ran on a Gateway-5400 computer system equipped with dual Intel Pentium processors running at 750 MHZ.

The listings for the sample application are provided in Appendix-F.

FIG. 40 depicts a partial view of the node function table for the sample application. The first column is a remarks field and is not a part of the node function table. The second field corresponds to the Rcp Gate num field 1705 of the node function structure FIG. 17, and the third field corresponds to the Max function invocations 1706 or local ring number 1707 of the node function structure, depending on whether the node function table entry is a node function or Rcp gate. It may be noted that the index values 0 thru 3 of the node function table serve as the Rcp Gate numbers and the index values 4 thru 7 of the node function table serve as the node function numbers.

In FIG. 35, the main function of the sample application opens the required files for processing and executes the Rcp statement Run_Pgm, which corresponds to the Run_Pgm function 3103 of the Rcp Runtime library. The Run_Pgm function loads the control tables from the Rcp load image file, and creates the frames, which in the case of this sample application is 1 (specified in the Create Frames Rcp statement). The Worker table is created and the workers, which in the case of this sample application is 2 (specified in the Create Workers Rcp Statement), are created. The workers are referred to as Worker-0 and Worker-1. Each of the two workers attempt to acquire the frame lock 1104 and only one of them succeeds, and the other waits indefinitely for a signal form the dispatcher. The main thread of the sample application which issued the Run_Pgm statement waits for all frames to finish, before it terminates.

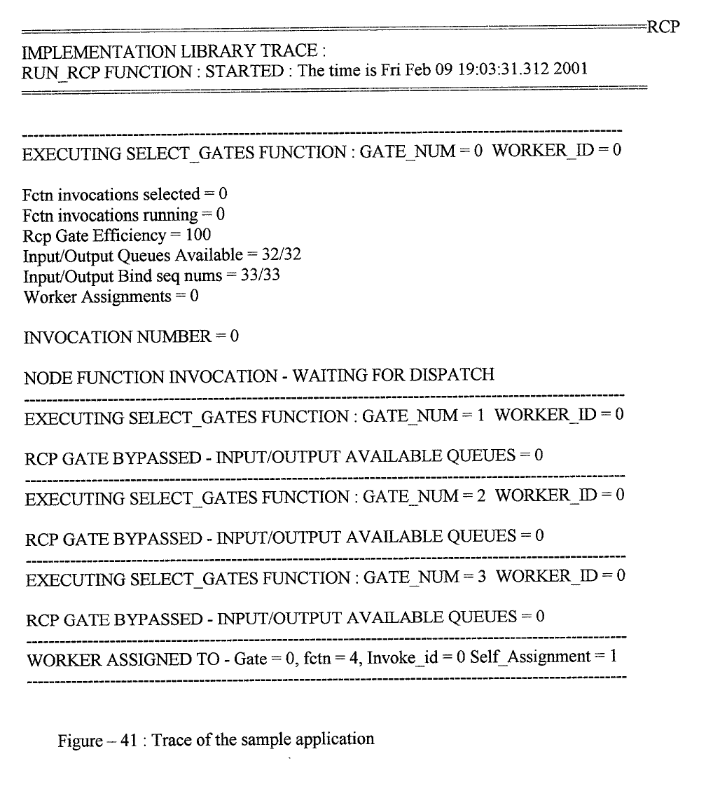

The trace of the sample application depicted in FIG. 41, indicates that Worker-0 succeeded in locking the frame. The Worker-0, executes the Run_Dispatcher function 3205, which subsequently executes the Select_Gates function 3206. The Select_Gates function walks through the Node function table FIG. 40, and executes the Bind_Virtual_Queues function 3207, for each of the four Rcp gates defined in the sample application. Of the four Rcp gates only Rcp gate claim Selector can successfully bind the queues, since its inputs are always ready, and outputs are not ready (available). The available queues (all 32) of the claim Queue array 3402 are bound to the Rcp gate. The node function invocation zero of the node function claim Selector is selected and the Rebind_Virtual_Queues function 3208 is executed to bind queues to the 0^{th} invocation of the node function claim Selector 3301. The node function invocation is then marked as WAITING FOR DISPATCH. The rest of the Rcp gates fail to bind the queues, and are bypassed. The Worker-0 executes, Dispatch_Fctns function 3212, which assigns the node function invocation of the claim selector function to the dispatcher itself (self assignment). The dispatcher completes the Run_Dispatcher function 3205, and now has a work assignment. It may be noted that the other worker is still waiting for a work assignment.

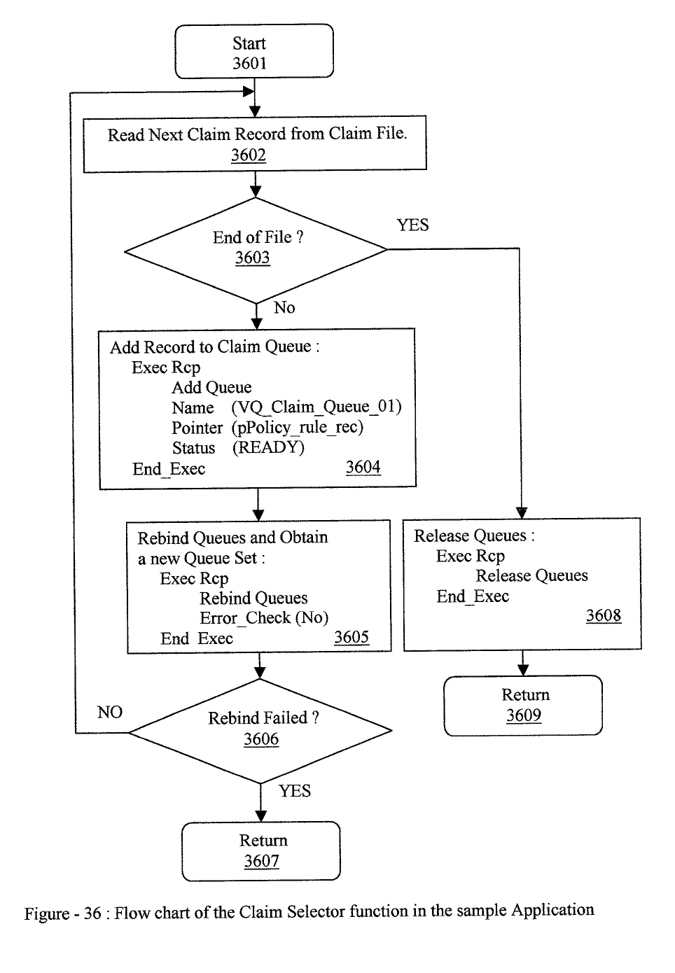

The Worker-0 will acquire the node function pointer of the claim selector function 3301, from the node function table and will invoke the node function with the Run_id parameter created from the Frame number and worker id. The logic of the node function claim selector 3301 is depicted in FIG. 36. The node function claim_Selector begins execution, and will read the next claim record, and will add the claim record to the claim Queue array 3402, via the virtual queue 3303 by the Rcp statement Add Queue. The queue is set to ready state, at the end of the add statement. The node function claim selector 3301 then executes the Rebind queues Rcp statement and acquires a new output queue, and the next claim record is read and added to the claim Queue array 3402, via the virtual queue 3303 by the Rcp statement Add Queue. This process continues until claim records are added to all 32 queues in the claim Queue array 3402. After the 32^{nd} iteration the node function claim Selector 3301, will receive a rebind failed return code when it executes the rebind statement. The node function claim Selector 3301, terminates further processing and returns back to the Run Worker function 3204 which invoked the node function.

The worker-0 then attempts to lock the frame and succeeds in acquiring the frame lock 1104, and assumes the role of the dispatcher. This time it finds that the claim processor node function 3305 is the only function that can be dispatched. It may be noted that the other worker is still waiting indefinitely for a work assignment from the dispatcher.

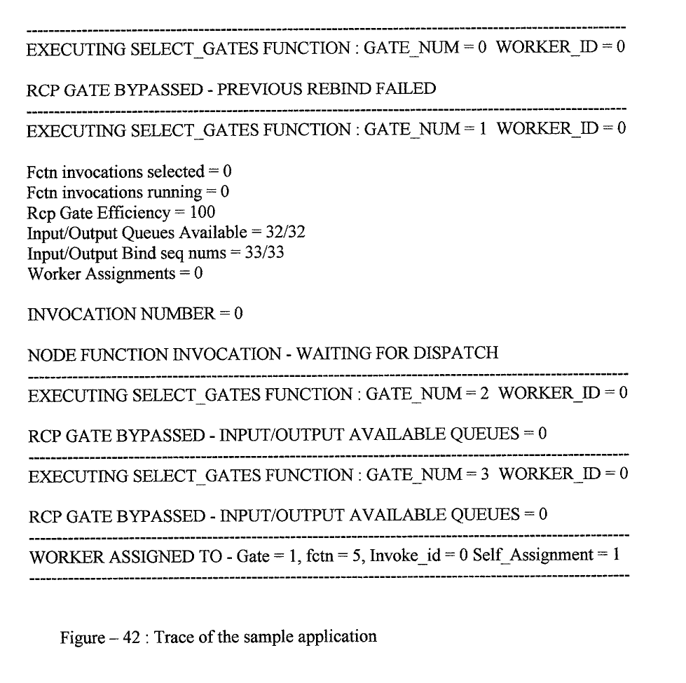

After the execution of the Bind_Virtual_Queues function 3207, and Rebind_Virtual_Queues function 3208, the 0^{th} invocation of the claim Processor node function 3305 is selected for dispatch and is dispatched by the Dispatch_Fctns function 3212, as depicted in FIG. 42. The dispatcher assigns the node function invocation to itself as a self assignment, and invokes the claim processor function 3305 with a Run_id parameter created from the combination of the frame number and worker number. The claim processor function 3305 begins to execute.

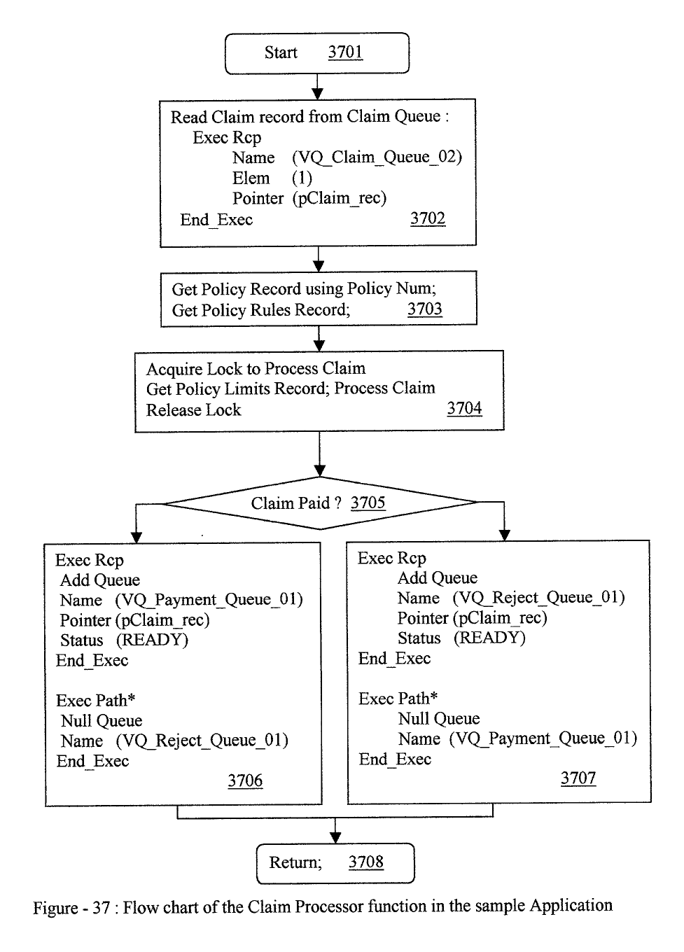

The logic of the claim processor node function 3305 is depicted in FIG. 37. The claim processor function reads the claim queue from the claim queue array 3402, reads the policy record from the policy file, reads the policy rules record from the policy rules file and the policy limits record from the policy limits file and determines if the claim should be paid or rejected, and accordingly adds the claim record to the Payment queue array 3404 or Reject queue array 3405. After 32 records are processed, the function fails to rebind and returns to the Run_Worker function which invoked the claim processor node function.

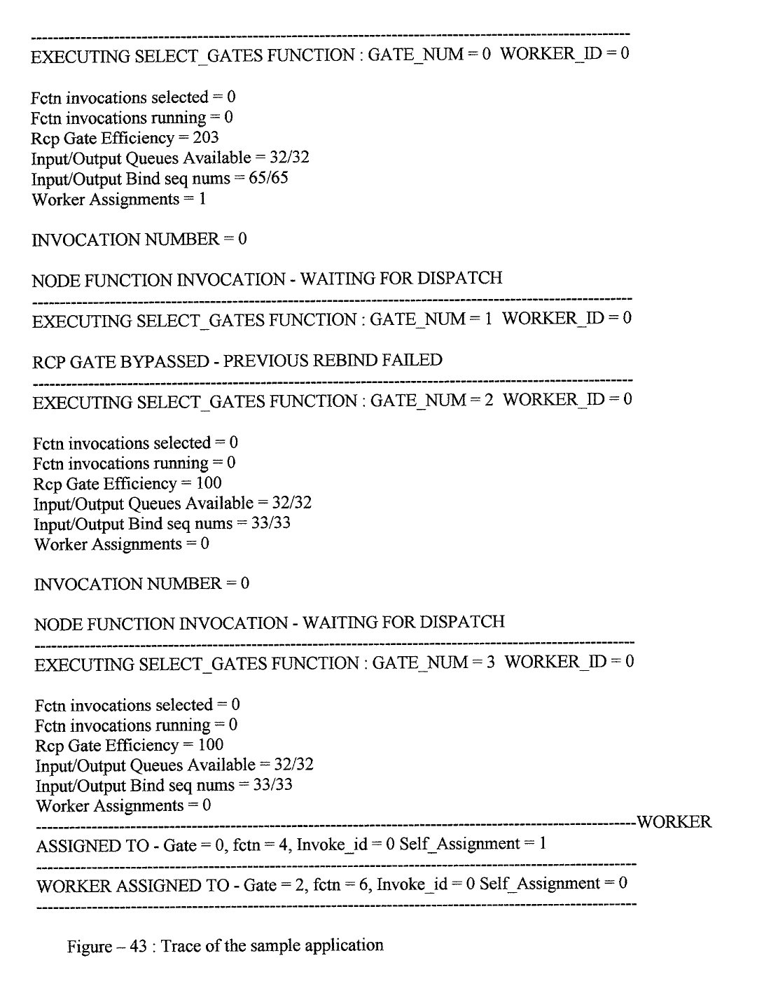

The worker-0 then attempts to lock the frame and succeeds and assumes the role of the dispatcher and finds that claim Selector node function 3301, and Reject node function 3312 can be dispatched, as depicted in the trace FIG. 43. It may be noted that the policy limits file is configured so that all incoming claims will be rejected. The dispatcher (worker-0) assigns claim selector node function 3301 to itself, and assigns Reject node function 3312 to worker-1.

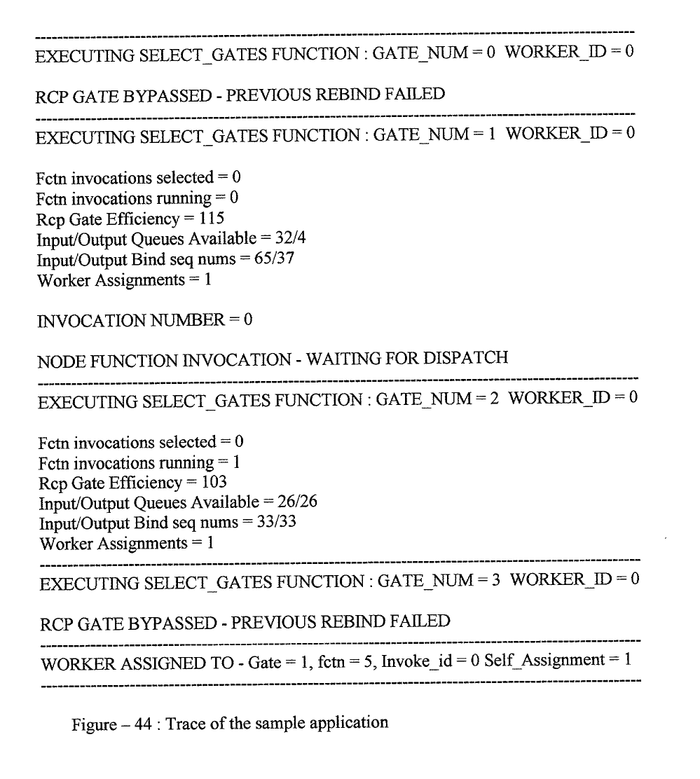

As depicted in FIG. 44, the worker-0 completes the execution of the claim selector node function 3301, before the Reject node function 3312, and then finds the claim processor node function 3305, as a suitable candidate for dispatching. It may be noted that dispatcher (worker-0) recognized that reject node function 3312 is running, in view of the trace statement in FIG. 44 “Fctn invocations running=1” under the trace heading “EXECUTING SELECT_GATES FUNCTION: GATE_NUM=2 WORKER_ID=0”. As depicted in figure-40, GATE_NUM=2 is Rcp gate Reject 3407, which is controlling Reject node function 3312.

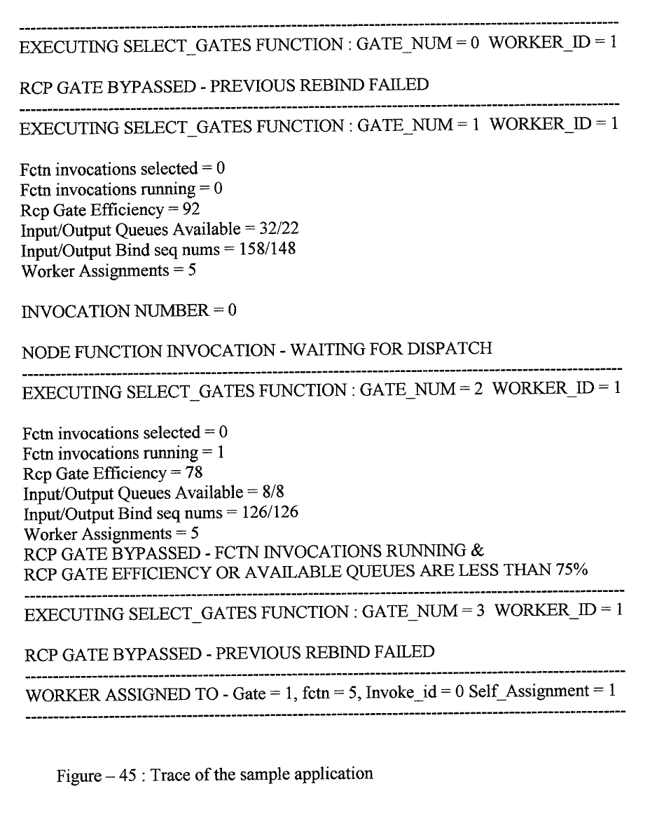

The execution of the node functions continues as explained above. As depicted in FIG. 45, at some point during the execution of the application, the worker-I completes the execution of the claim selector node function 3301, and assumes the role of the dispatcher by locking the frame lock 1104. The dispatcher determines that the claim processor node function 3305, is a suitable candidate for dispatching, and assigns the 0^{th} invocation of the claim processor node function to itself.

It may be noted that the dispatcher (worker-1) recognized that the reject node function 3312 is running, and the comment Rcp Gate bypassed in the trace is interesting, since the comment is absent in FIG. 44. The comment is absent in FIG. 44 because the Rcp Gate efficiency is above 75% and available queues 26 are above 75% mark which is 24, and the Rcp gate reject 3407, determined that another invocation can be started for the Reject node function 3312, but since the Reject node function 3312, has a maximum of only one invocation, it returned silently.

In contrast, in FIG. 45, the same Rcp gate Reject 3407 threw a comment when it recognized an invocation of the reject node function 3312 is running, because the Rcp gate reject 3407 determined that another invocation can be started for the Reject node function, but since the available queues 8, are less than 75% mark which is 24, it bypassed further processing for the Rcp gate Reject 3407.

It may be noted that worker-0 is running the reject node function 3312, since worker-1 is acting as the dispatcher and determined that reject node function invocation is running, and since there are only two workers in the frame. Please refer to FIG. 45.

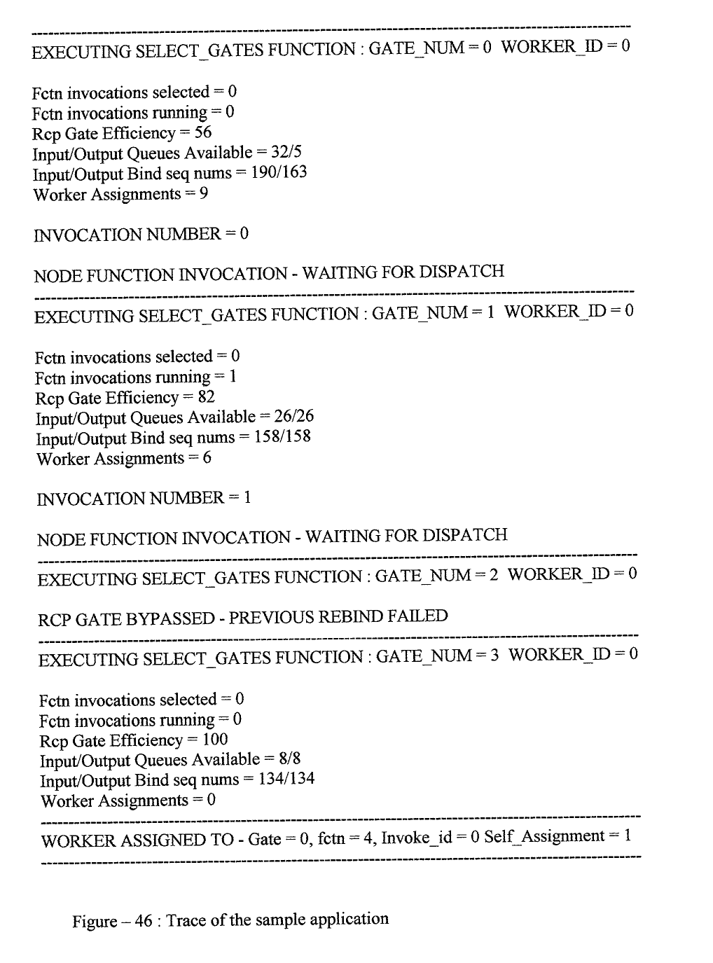

The worker-0 completes the execution of the reject node function 3312 and acquires the frame lock 1104 and assumes the role of the dispatcher, as depicted in FIG. 46. The worker-0 executes the Select_Gates function 3206, whereby the Rcp Gate claim selector 3401 determines that the claim selector node function 3301 can be dispatched. The Rcp Gate claim processor 3403, determines that an invocation of the claim processor node function 3305 is running, and it selects another invocation of the claim processor node function 3305 for dispatch since the efficiency of the Rcp Gate claim Processor 3403, is 82% above the 75% mark, and the available queues are 26, above the 75% mark which is 24. It may be noted that the Rcp Gate efficiency is computed as follows (using the data for Rcp gate claim processor Gate_Num=1 in FIG. 46):

$$\begin{matrix}Rcp gate efficiency = \begin{matrix}Output bind seq num * 100 \text{/} min ( min capacity of input queue array , \\ min capacity of output queue arrays ) * Number of worker assignments\end{matrix} \\ = min ( 158 , 158 ) * 100 / min ( 32 , 32 ) * 6 \\ = 158 * 100 / 32 * 6 \\ = 82 \%\end{matrix}$$

As depicted in the FIG. 46, only the claim selector node function 3301 is dispatched, since worker-1 is still executing the 0th invocation of the claim processor node function 3305, the new invocation of the claim processor node function 3305 will have to wait for the next available worker. It may be noted that the dispatcher assigned the claim selector node function invocation to itself (worker-0).

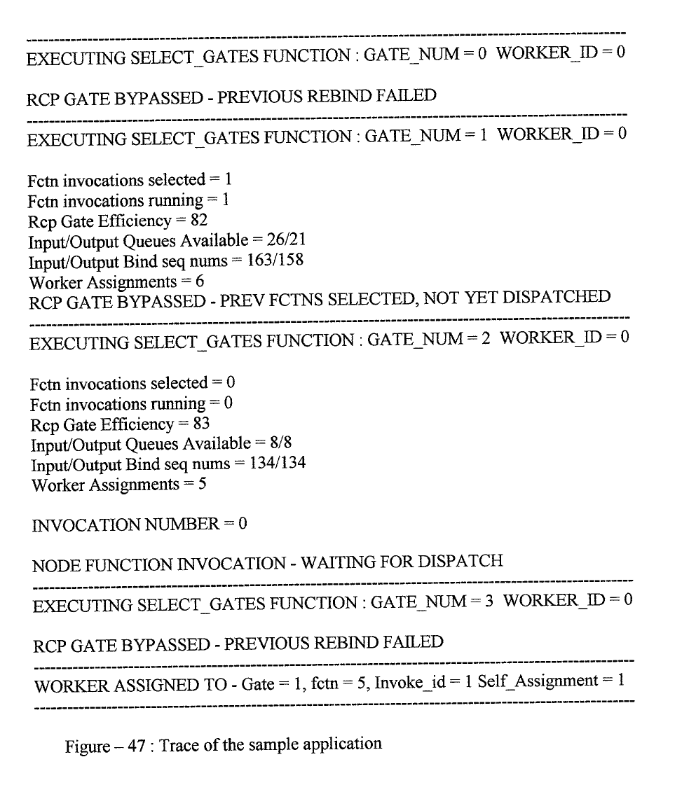

The worker-0 completes the execution of the claim selector node function invocation and acquires the frame lock 1104 and assumes the role of the dispatcher, as depicted in FIG. 47. The Rcp Gate claim selector 3401 is bypassed since rebind queues function failed, during the execution of the claim selector node function invocation in the previous cycle. The Rcp Gate claim processor 3403 is bypassed due to the pending node function invocation, which is selected but not yet dispatched. The Rcp Gate reject 3407 selects the 0^{th} invocation of the reject node function 3312 for dispatch. The worker-0 executes the Dispatch_Fctns function 3312, which assigns the dispatcher (worker-0) to the node function invocation of the claim processor which is selected but not yet dispatched.

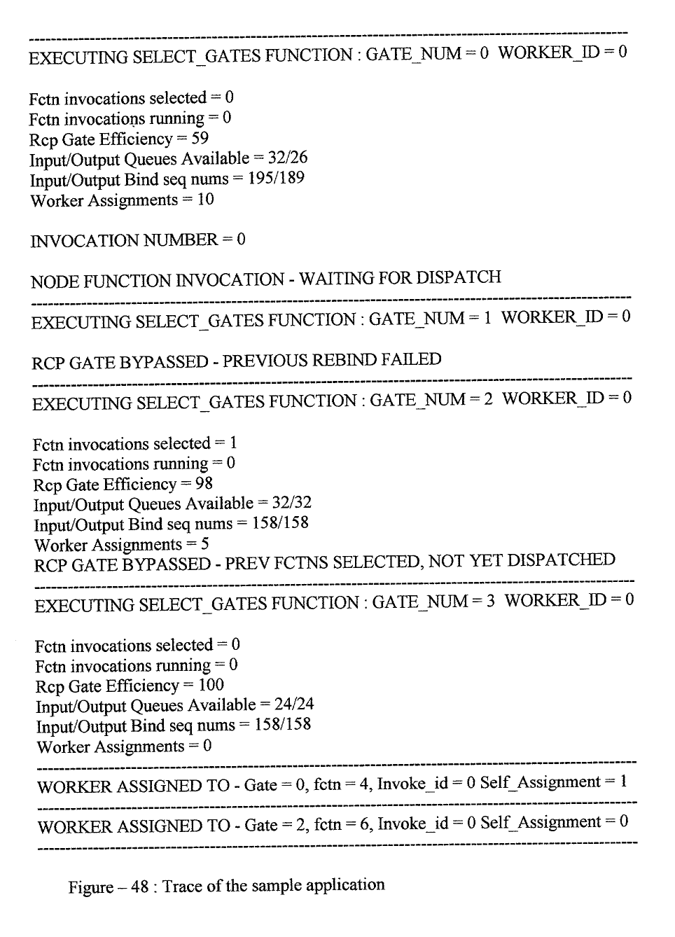

Both worker-0 and worker-1 now execute the claim processor node function invocations one and zero respectively. The worker-0 completes the execution of the claim processor node function invocation 3305 and acquires the frame lock 1104 and assumes the role of the dispatcher, as depicted in FIG. 48. The Rcp Gate claim Selector 3401 selects the node function claim selector 3301 for dispatch. The Rcp Gate claim processor 3403, is bypassed since both the invocations of the node function claim processor have failed to rebind the queues. The Rcp Gate Reject 3407 is bypassed since the previous invocation is yet to be dispatched. The worker-0 then executes the dispatch_fctns function, which assigns the claim selector node function invocation to itself (worker-0), and the reject node function invocation to worker-1.

The Rcp runtime continues as explained above, until the end of claim file is detected by the claim selector, which being the top level node function will execute release queues Rcp statement. Since the claim selector node function 3301 has only one invocation, the Rcp Gate will terminate immediately, and the producer count of the claim Queue array 3402 is reduced by 1, to zero. The lower level Rcp Gate, claim Processor 3403 will check the producer count of claim Queue array, and when there are no pending ready queues to be processed, it will terminate itself, and will reduce the producer count of Payment Queue array 3404 and the producer count of the Reject Queue array 3405, by 1 to zero. This in turn prompts the Rcp Gates Payment 3406 and Reject 3407 to terminate, when there are no pending ready queues in the payment 3404 and reject 3405 queue arrays. When all the Rcp gates terminate, The Select_Gates function 3206, will return zero for running functions, and the Run_Dispatcher function 3205 will interpret that as an idle condition, and will return an idle return code to the Run_Worker function 3204. The Run_Worker function 3204 will execute the Frame_Termination function 3217, when it receives a negative return code from the Run_Dispatcher function 3205. The Frame_Termination function 3215 in turn executes the Rcp_Finish function using the function pointer received by the Run_Pgm function, and passes the frame number as a parameter. When all the frames in the program have terminated the Rcp_finish function is executed again, and the program begins to destroy the frames and its contents and shuts itself down in an orderly fashion.

### CONCLUSION, RAMIFICATIONS, AND SCOPE OF INVENTION

Accordingly, the reader will see that the parallel computing architecture named RCP, can be used to automate the development of multithreaded applications. Furthermore the RCP architecture has several additional advantages in that

It can be implemented for a variety of host languages, and operating systems.

It can be implemented for a variety of processor architectures, and the underlying details of the processor architectures are shielded from the developer.

Load balancing is automatically provided by the Rcp runtime, which has significant importance in parallel computing.

The building block approach allows for a clear separation between the application design from application development, and a person with knowledge of the application can build the resource definitions, and the node functions can be developed by an application developer.

The RCP architecture is fairly robust and other building blocks like the Rcp Gate can be incorporated into the architecture for additional services.

Although the description above contains many specificities, these should not be construed as limiting the scope of the invention but as merely providing illustrations of some of the presently preferred embodiments of this invention.

A preferred embodiment of this invention calls for implementation on a computing machine equipped with symmetrical multiprocessors, however the invention is also applicable to massively parallel architectures as well as uniprocessor environments. In addition, although the various methods described are conveniently implemented on a general purpose computer, in software, one of ordinary skill in the art would also recognize that such methods may be carried out in hardware, in firmware, or in more specialized apparatus constructed to perform the required method steps.

### REFERENCES

The following references are incorporated by references, into the present application:

1) C How to Program: Second Edition H M DEITEL/P J DEITEL:Prentice Hall:ISBN 0-13-226119-7

2) C++ The Complete Reference: Second Edition Herbert Schildt: McGraw Hill: ISBN 0-07-882123-1

3) Advanced Windows: Third Edition Jeffrey Richter: Microsoft Press: ISBN 1-57231-548-2

4) Advanced topics in Data Flow Computing and MultiThreading: Guang R Gao, Lubomir Bic, and Jean-Luc Gaudiot: IEEE Computer Society Press: ISBN 0-8186-6542-4

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A system, and method for automating the development of multithreaded applications running on computing machines equipped with symmetrical multiple processors, and shared memory.
1) A system including a plurality of symmetrical processors, and a shared memory, operating under the control of an operating system and utilizing the runtime libraries of a programming language, called host language, comprising:
a) Resource control programming (Rcp) runtime means, a translator, and a set of run time libraries, for providing translation and run time support to the application.
b) Function means a sequence of instructions which accomplish a particular task.
c) Invocation means a particular instance of execution, of said function.
d) Element means a block of storage allocated in said shared memory.
e) Queue means a container for a plurality of said elements and control structures for synchronizing access to said elements, whereby said elements contained in the queue are accessed by an unique identification number called element number.
f) Queue array means a container for a plurality of said queues and control structures, for storing said queues, whereby said queues contained in the queue array are accessed by an unique identification number called queue array number.
g) Virtual queue means a special kind of said queue which contains a reference to said queue or a combination of said queue array and said queue.
h) Rcp gate means a special function whose run time behavior is supplied by said Rcp run time libraries, and which comprises of zero or more said queues or said queue arrays on the input side, and zero or more queue arrays on the output side, and a control table called bind table, and control variables called inputs pending, inputs available, outputs available, outputs processed, number of assignments made, and next anticipated input identification number.
i) Node function means said function with a predefined signature, which comprises of zero or more said virtual queues defined on the input side, and zero or more said virtual queues defined on the out put side, and has control structures for storing the runtime information of said invocations, and is associated with said Rcp gate.
j) Node function invocation means a particular instance of execution of said node function.
k) Producer means said node function which has one or more said virtual queues defined on the output side, or said Rcp gate which has one or more said queue arrays defined on the output side.
l) Consumer means said node function which has one or more said virtual queues defined on the input side, or said rcp gate which has one or more said queues or said queue arrays defined on the input side.
m) Local ring means a control structure comprising of control information called bind info bits, and bind sequence number, which are used for synchronizing access, and assigning unique sequence numbers to data written to said queues of said queue arrays defined on the output side of said Rcp gate, such that whenever said queue arrays defined on the output side of the Rcp Gate are shared, by other said Rcp gates, the said local ring structure is shared, by all said Rcp Gates.
n) Ready state of said queue means that said producer has written data to the queue and has marked the queue as ready, for further processing by said consumers of the queue.
o) Not ready state of said queue means that the queue is available for output, and that said consumers of the queue, if any, are not currently using the queue, and that there is no data available for use in the queue.
p) Null state of said queue means that said producer has no data to write to the queue and has marked the queue as null, so that said consumers can avoid processing the queue.
q) Input Queue index means an index number, such that all said queues, identified by the index number, within said queue arrays, defined on the input side of said Rcp gate, are in said ready state.
r) Output Queue index means an index number, such that all said queues, identified by the index number, within said queue arrays, defined on the output side of said Rcp gate, are in said not ready state.
s) Bind Sequence number means a sequential number assigned by said Rcp gate to said queues, at said output queue index.
t) Queue disposition means said queue array, to which said queue under consideration belonging to another said queue array will be copied, when the queue is released by all of its said consumers.
u) Worker means a thread, and control structures for controlling said thread, having an unique identification number called worker number, within said frame.
v) Rcp resource means any of said queues, said queue arrays, said virtual queues, said node functions, said Rcp gates, said local rings, and said workers.
w) Frame means a partition within the application process, containing control tables for storing said Rcp resource definitions and their runtime statuses, and having an unique identification number called, frame number.
x) Run identification or Run_id means a control structure received by said node function invocation when it is invoked at run time, and which is comprised of said frame number and said worker number.
y) Resource control programming (Rcp) Statements means, a high level language mechanism for defining, accessing and controlling said Rcp resources.
z) Dispatcher means said worker within said frame, which acquired a lock contained in said control structures of said frame, whereby said worker can assign, said node function invocations waiting for execution, to itself, and other said workers which are idle, within said frame.

2) A method of automating the development of multithread applications in a computing system, containing a plurality of symmetrical multiple processors, comprises the steps of:
a) Defining and initializing said Rcp resources, as per the requirements of the application.
b) Specifying said Rcp Statements in the source files of the application, for accessing, modifying and controlling said Rcp resources, defined for the application.
c) Translating said Rcp statements into host language statements or internal control structures, and storing said internal control structures in a load image file.
d) Generating a function called Rcp_Init function, for initializing said Rcp resources defined for the application.
e) Building an executable module for the application, by compiling and optionally linking the translated source files and said Rcp_Init function generated by said translator.
f) Invoking said Rcp Runtime by issuing the Rcp statement “Run Pgm” from the application.
g) Waiting for all said frames to terminate

3) The method in claim 2, further comprises of:
a) Initializing said Rcp Runtime environment, and creating said frames, and said workers within each of said frames, and executing said Rcp_nit function generated by said translator, whereby the function pointers to said node functions are acquired by the Rcp runtime library.
b) Determining said node function invocations which can be executed, within each said frame, and executing said node functions within each said frame, until a Stop, abend, or Idle event is generated within each said frame.

4) The method in claim 3, further comprises of:
a) Performing an activity called binding whereby a complete set of said queues, identified by said input queue index on the input side of said Rcp gate and a complete set of said queues identified by said output queue index on the output side of said rcp gate are determined and stored in the control structures of said Rcp gate. The queue indices on the input and output side of the Rcp gate are collectively called a binding. This activity is carried out for each said Rcp gate, in each said frame, by said dispatcher of said frame.
b) Determining if said Rcp gate is running efficiently, and selecting said node function invocation, from a plurality of said node function invocations waiting for execution.
c) Performing an activity called rebind, whereby said Rcp gate associates said binding, with said node function invocation.
d) Assigning a worker to said node function invocation bound to said queues.
e) Executing said node function invocation, which contains host language statements, and returning back to said rcp runtime.

5) The method in claim 4, performing an activity called binding, further comprises the steps of:
a) Terminating said Rcp Gate when said input queues contained in said input queue arrays are all in said not ready state, and said producers for at least one of the queue arrays have terminated
b) Determining for each valid value of said input queue index of said Rcp gate, if said bind sequence number of said queues, is greater than or equal to said next anticipated input identification number, stored in said control structures of said Rcp gate.
c) Storing said bind sequence number, and said input index, determined above, in said “bind table”, of said Rcp gate, at a location in said bind table, obtained by hashing said bind sequence number with the size of said bind table.
d) Determining if any said queues identified by said input queue index are marked as null, and setting an internal flag called null flag in said bind table, where the bind table entry is identified by said bind sequence number of the queues identified by the input queue index,
e) Determining if there are any gaps in said bind sequence numbers, stored in said bind table, and incrementing said inputs pending counter of said Rcp gate with number of inputs after the first gap in said bind sequence numbers, and incrementing said inputs available counter of said Rcp gate, with number of inputs without any gaps in said bind sequence numbers.
f) Determining the next valid value of said output queue index of said Rcp gate, and checking that the corresponding bind info bit stored in said local ring is zero, and when these conditions are met, said output queue index of said Rcp gate, and said next bind sequence number of said local ring are stored in said bind table, at the location identified by an internal index, which sequentially traverses said bind table. The next bind sequence number of said local ring is incremented by 1. The corresponding bind info bit of the local ring is set to 1, and said outputs available counter of said Rcp gate is incremented. The said local ring is accessed in a thread safe manner.
g) Determining if said inputs available counter and said outputs available counter of said Rcp gate are positive, and returning a special return code, to signal failure of the bind activity, if any of said counters are zero.

6) The method in claim 4, determining if said Rcp gate is running efficiently, further comprises of:
Determining the efficiency of said Rcp gate, by the formula
Rcp Gate efficiency=(Num of outputs processed by the Rcp Gate*100)/(Num of worker assignments for all the invocations of the node functions*min(min(capacity of input queue arrays), min(capacity of output queue arrays)));
If number of worker assignments for all node function invocations, determined by the number of assignments made value of said Rcp gate, is zero, then said Rcp gate efficiency is set to 100%. If said producers have terminated for any one of said queue arrays on input side of said Rcp gate, then said Rcp gate efficiency is set to 100%.
If said Rcp gate efficieny is below 25%, and if said inputs available and said outputs available counters of said Rcp gate are less than 25% of the minimum capacity of said queue arrays of said Rcp gate, further processing is bypassed, since said Rcp gate is operating poorly, which means that more data should be accumulated before said node function invocations of said Rcp gate are started.
If said Rcp gate efficiency is above 75%, and if said inputs available and said outputs available counters of said Rcp gate are greater than 75% of the minimum capacity of said queue arrays of said Rcp gate, then another invocation of said node function can be started, if said node function invocation is available for execution.

7) The method in claim 4, performing an activity called rebind, further comprises the steps of:
a) Selecting said bind table entry, in a thread safe manner, using an index called “Rebind index” stored in the control structures of said Rcp gate, which traverses said bind table entries sequentially, and wraps around after the last entry.
b) Skipping said bind table entry if the null flag of the entry is set to 1.
c) Copying said input queue index, said output queue index, and said bind sequence number from said bind table entry identified by said Rebind index to the control structures of said node function invocation,
d) Marking said bind table entry identified by said rebind index as “Rebind complete”.

8) The method in claim 4, assigning a worker to said node function, comprises of:
Marking said node function invocation as Waiting for execution, so that it will be dispatched for execution by said dispatcher, when said worker becomes available.

9) The method in claim 4, executing said node function invocation, and returning back to said rcp runtime, further comprises the following steps:
a) Executing the host language statements.
b) Optionally reading said queues on the input side of said node function by executing Rcp statement “Read Queue”.
c) Optionally writing data to said queues on the output side of said node function, and setting it to said ready state by executing Rcp statement “Add Queue”, whereby said bind sequence number contained in the control structures of said node function invocation, is copied to the control structures of said output queue array, when said queue belonging to said queue array is set to said ready state.
d) Terminating said node function invocation by executing the rcp statement “Release queues”, when said Rcp gate associated with said node function has no input queue arrays, defined on its input side.
e) Optionally executing a Rcp statement “Rebind queues”, to acquire another set of said queues, and re executing the host language statements of said node function., until said Rcp statement “Rebind queues” returns a special return code to signal failure, whereby control is returned back to the Rcp run time.

10) The method in claim 9, optionally executing said Rcp statement “Rebind queues”, to acquire another set of said input and output queues, further comprises the steps of:
a) Performing an operation called unbind, whereby said input and output queues bound to said node function invocation, are released.

11) The method in claim 10, performing an operation called unbind, further comprises the steps of:
a) Releasing said queues bound to said node function invocation on the input side, whereby for each said queue, a control field in said control structures of said queue, containing current count of said consumers, is decremented by 1, and when the current count of said consumers drops down to zero, said queue control structures are reset, and said queue is set to said not ready state.
b) Releasing said queues bound to said node function invocation on the output side, whereby said bind info bit of said local ring, corresponding to said output queue index contained in the control structures of said node function invocation is set to zero, in a thread safe manner.
